(19) United States
(12) Patent Application Publication
(10) Pub. No.: US 2014/0149273 A1
(43) Pub. Date: May 29, 2014

(54) Market Microstructure Data Method and Appliance

(71) Applicants: Rick Angell, Evanston, IL (US); Mehmet Yanilmaz, Chicago, IL (US)

(72) Inventors: Rick Angell, Evanston, IL (US); Mehmet Yanilmaz, Chicago, IL (US)

(21) Appl. No.: 14/093,234

(22) Filed: Nov. 29, 2013

Related U.S. Application Data
(60) Provisional application No. 61/731,107, filed on Nov. 29, 2012.

(51) Int. Cl. G06Q 40/04

(52) U.S. Cl. CPC G06Q 40/04
USPC 705/37

(57) ABSTRACT

A system and apparatus generates trading algorithms as data feeds. These data feeds are derived from market data feeds from electronic trading platforms. Functions of invention include the generation of the feeds as market microstructure analytics, trading algorithm building blocks, market behavior and risk estimates that are synchronized with underlying market data feeds. The invention incorporates utilities for agent-driven simulation of multiple electronic markets, and real-time testing and calibration of trading strategies. By delivering critical market dynamics that have not been available so far to market participants, the invention is projected to cut the cost of designing, implementing, and validating trading strategies while also increasing trading performance significantly. The invention will have an equalizing effect on trading by enabling retail investors to remain competitive with high speed traders. This equalizing effect will complement many trading platforms' initiatives for attracting retail flow to enhance their trading volumes and liquidity quality.

### FIELD OF THE INVENTION

This invention relates to the generation and real time delivery of market microstructure data, risk metrics, and trading algorithms, real-time calibration of these algorithms by on-line market simulation and emulation for traders, brokers/dealers, commodity futures merchants (CFMs), and exchanges.

### BACKGROUND OF THE INVENTION

The methods and the apparatus of this invention focus on the dynamics of the market microstructure. Market microstructure entails the dynamics of markets for stocks, foreign exchange (FX), commodities, debt instruments; futures, options, swaps, swaptions; contracts that are generated by securitizing and or collateralizing these instruments. Factors that shape market microstructure dynamics are the rules for market access and trading; functions of the market operators and market intermediaries such as dealers or brokers; transaction costs, the structure and the transparency of the market data that is made available to market participants; the features of the technologies deployed for operating these markets. Elements of market dynamics include quotes and orders placed by market participants; market volume in terms of the numbers of transactions or aggregate sizes of orders that are executed; price movements ensuing from executions of orders; market liquidity in terms of outstanding quotes or orders in the market any given time or across different time horizons; market volatility in terms of variations in quotes, volumes, prices.

Most financial markets are organized as two-sided markets involving buyers and sellers. These markets are consequently called double-auction systems since both buyers and sellers are effectively engaged in an auction, whereby sellers solicit purchasing bids and buyers sell offers. Organized exchanges maintain a system to regulate transactions among these buyers and sellers across time. For the orderly operation of the market, there are fixed criteria for determining transaction precedence based on (i) the highest bid and lowest offer; (ii) large size before small, with random selection if two trades are the same size and the precedence time criterion is not applicable; (iii) public orders having typically precedence over members' own orders. There are typically subtle differences in each market for running these double-auction systems. These subtle differences arise from the rules for market access and trading and the transparency of the market data that is made available to market participants.

Trading venues operate according to following models: quote driven, order driven or hybrids of both. Various auction mechanisms can be deployed for these operating models. Order-driven market is an auction driven market where prices are determined by the publication of orders to buy or sell. The market operator matches orders and executes trades. If the market is operated electronically, market participants are mostly anonymous at most exchanges.

Quote-driven market is an exchange where prices are determined from quotations made by market makers or dealers. Quote-driven market is also referred to as a price-driven market. The main difference between quote and order driven markets lies in what is displayed in the market in terms of orders and bid and ask prices. The order driven market typically displays all of the bids and asks.

Market makers are often specialists with special privileges and obligations for providing liquidity to the market. In some electronic markets, market makers can also be any participant that posts liquidity in the market to benefit from liquidity rebates provided by the market. Quoters can be anonymous or transparent, depending on the market. In many over-the-counter (OTC) markets, buyers and sellers are also quoters. They provide quotes and modify their quotes in quote exchange sessions with other market participants, until prices are agreed by two or more parties of a quote-driven auction session. This type of quote-driven trading model is also used in some exchanges for contracts with limited liquidity.

Hybrid markets combine both order-driven and quote-driven features. For example, several FX trading operators such as ICAP provide order-driven platforms as well as quote-driven interdealer market. The ensuing combined transaction flow from orders and quotes typically enhances volumes and liquidities on both of these markets.

In both quote and order driven markets, a client may be working with a single intermediary (broker of CFM) or multiple intermediaries that match orders from buyers and sellers. The use of multiple intermediaries is common in interdealer markets which are typically quote-driven. This is also becoming common in electronic markets, where a client's order may be executed not by the trade execution algorithms of the client's broker (or CFM), but by another broker's trade execution algorithm, whereby these two brokers have agreements in place to share technology and trade execution servers on behalf of their clients. Any contract type can be traders in quote or order driven markets or both, including cash, futures, options, fixed income, swaps, and swaptions. Asset types that be traded at these markets include stocks, FX, bonds, credit and commodities.

These markets can be operated in electronic exchanges or as OTC markets, each with its own mechanisms and organizations for managing counterparty risk and clearing. A quote driven market typically provides the bids and asks other designated parties. Both quote and order driven markets, as well as their hybrids, can be run according specific auction rules. Buyers and sellers, including brokers and dealers who provide them with access to markets, can be anonymous or disclosed to other market participants in any of these markets, depending on the market's operating rules.

Generators of market data include:
1. Trading venues where market data originates;
2. Data resellers and trading technology providers that republish the data with their own added value (including data aggregation, direct market access (DMA), time stamp consolidation—ticker plants, etc.; examples include Bloomberg, Thomson Reuters, etc.);
3. Broker/dealers and commodity futures merchants that provide some or all of the services of data resellers and trading technology providers with additional services of their own (market data/trading message consolidation for their clients; real time and historic data relational data bases for storing market data and trading information);examples include Investment Technology Group, etc.).

Trading venues where market data originates include:
1. Exchanges (e.g., NYSE, NASDAQ for equities, CME, Eurex for futures, CBOE for options, etc. spot FX trading platforms);
2. Electronic communication networks (e.g., ARCA for equities; Currenex, FXAll for FX, etc.);
3. Opaque dark pools—dark pools that publish top of the limit order book (e.g., Gain Capital, Hot Spot, etc.);
4. Internal crossing networks (e.g., ICAP's electronic markets for fixed income);
5. Interdealers, multi-tier brokerage with voice and electronic networks for FX, fixed income, credit contracts;
6. OTC trading platforms for FX, fixed income, credit, swaps, forwards, options, etc.

Financial market data from electronic markets include the following:
1. Real-time price and volume data, or tick data: this type of data is updated each time a trade takes place.
2. Index data: data that is computed as a composite of several real time price data feeds according to specific formulas.
3. Real time limit order book data: data for sums of limit orders at different depths of bid and ask prices on both sides of the market. This data stream is updated at the arrival or removal of each limit order—or message—that is displayed. Depending on the trading venue, the depth of the published order book can be fixed or dynamically changing according to bid/ask prices.
4. Real time top of the book data: top of the book prices on bid and ask sides.
5. Normalized data: data that is normalized according to various criteria. Common normalization models include time-normalization such as data interpolated at regular time intervals, data published as bar charts. Data can be normalized as ratios of one data set to another data set, such as data that are normalized to index data.
6. Real time market status data: this data provides market status data based on volume, volatility, time, and price. Examples of this type of data include: (i) volume weighted average price (VWAP) or time weighted average price; (ii) mid-point of bid/ask spread; (iii) volatility index data.
7. Historical data: stored data from 1-6 above).
8. Reference data: information about the trading rules and the trading calendar of a particular market.

The dynamics of order types, order books, order flow and ensuing liquidity and volume profiles, and the degree of disclosure of market information are the principal constituents of market microstructure. Volume is the amount of contracts that are traded in a given market over a defined period of time. Rates of change of volume profiles and the persistence of these rates reflect the strengths of trends in a market.

Basic order types that are offered by most trading platforms are limit order, market order, stop order. Some order types may not be provided by the trading venue but may be offered by brokers as means of customizing their clients' trading requirements. Some other order types may not be provided by trading venues but are provided by brokers.

The market order is an order to transact a pre specified number of shares at market price, which will cause an immediate execution, but are subject to price impact. The limit order is an order to transact a pre specified number of shares at a pre specified price, which will not cause an immediate execution. Limit orders can approximate market orders' price performance if market entry and exit prices are effectively calibrated according to market dynamics. Strategies with limit orders can be designed to collect rebates by providing liquidity to markets. A key challenge in devising entry and exit points to order books is the estimation of the size of hidden limit orders that are not shown in the order book, as well as the estimation of the traffic of market orders by traders who remove liquidity from the order book.

A stop order is an order to buy or sell a stock once the price of the stock reaches a specified price, known as the stop price. When the specified price is reached, the stop order becomes a market order. Stop orders are typically used to protect an unrealized gain on a position. If a contract moves down and a specified price is reached, stop orders also help minimize the losses by selling the position at the market. Both institutional investors who trade large volumes and retail investors with small lots seek the protection of stop orders for their positions. Traders typically use a buy stop order when buying stock to limit a loss or protect a profit on short sales. The order is entered at a stop price that is always above the current market price. A sell stop order helps to avoid further losses or to protect a profit that exists if a stock price continues to drop. A stop order to sell is always placed below the current market price. A stop-limit order is an order to buy or sell a stock that combines the features of a stop order and a limit order. Once the stop price is reached, the stop-limit order becomes a limit order to buy or to sell at a specified price. A third type of stop order is the trailing stop order is an order where the stop price will trail either the current ask or current bid by the number of points specified by the trader.

When offers to buy and sell at different prices and quantities of orders that are offered at these prices are displayed by markets, this data constitutes the order book. When only the best offers to buy or sell are displayed, then the limit order book is referred to as level 1 order book. When the limit order book is displayed at larger depths, then the limit order book is called a level 2 order book. The depth of the limit order book is typically best five or best ten price levels at buy and sell sides, or it can be dynamic and publish any bids and asks.

Liquidity is the instantaneous capture of the rate of change of volume profiles rate in terms of available buy and sell orders that are displaced in the open limit order book. If volumes are traded typically in relatively small lots, obviously, the order book will consequently exhibit liquidity, possibly across its whole level 2 profile. Although the term liquidity is widely used in finance literatures, its meaning is loosely defined and there is no quantitative measure for it. Generally, liquid markets mean an ability to quickly trade stocks without causing a significant impact on the stock price. Based on the difference in methods of executions, traders placing limit and market orders are called liquidity providers and liquidity takers respectively. For the scope of this patent application, liquidity refers to the rate of order traffic in the market, including: visible numbers of bid and ask offers in the limit order books, the total volume of these orders; estimates of hidden limit orders, and market orders. Liquidity is related to other metrics for estimating trade sizes and trading horizons. These metrics are price impact, time-to-fill, and probability of fill of various orders.

Market volatility often refers to ranges of price fluctuations. These fluctuations are correlated to volume and liquidity profiles across different time horizons. For instance, a high volume market with high liquidity may exhibit low volatility at intraday measures, whereas it may exhibit high volatility at tick frequencies due to large buy/sell activity that is taking place at full order book depth. Short and longer term volatilities may exhibit a scalable and typically nonlinear relationship among these different time horizons. These nonlinear relationships are often fractal in nature. Depending on short term volume fluctuations and trending patterns of the market, these fractal relationships can be multi fractal.

Latency profiles for accessing markets vary greatly according to methods used to communicate with exchanges. Higher latencies make the prospects of capturing and executing trading opportunities within short term horizons difficult. Also, longer latencies cause the trading strategy to inherently include implied forecasting which needs to be accounted for in the design of the strategy. If the strategy is not latency-sensitive—for example a strategy that generates relatively infrequent trading signals by capturing large price variations and spreads, then this strategy can be designed to rely on off-the-shelf execution algorithms. These algorithms are provided by off-the-shelf trading software, DMA services, brokers dealers, data feed providers, among others. Trading with such strategies at highly volatile markets often causes substantial slippage and missing the target price for filling the order, also referred to as implementation shortfall. Consequently, DMA services and broker/dealers spend considerable effort to come up with algorithms to minimize this shortfall. When connected to markets directly, the advantage in latency minimization will be lost unless one's own collocated execution algorithms are used.

Volume, liquidity and volatility are often empirically observed to be correlated. Highly liquid markets with relatively smaller fluctuations in volumes often exhibit high short-term volatilities. When trading a given contract for long/short positions, this short-term volatility is often hard to track. Similarly, when the trading strategy requires the tracking of the spread between two contracts, these types of markets exhibit tight spreads. Devising market entries and exits are becoming increasingly difficult to design for high frequency trading, since high liquidity fluctuations are often perceived as noise. However, noise can be discerned to its constituents and be traded against if the trading system benefits from competitively low latency and fast execution infrastructure. Price and volume trends typically exhibit lead/lag patterns (depending on down trending or up trending markets) that may exhibit time scalability. Hence, price volatility usually provides insight about volume volatility. The scalability of the lead/lag is often correlated to liquidity patterns in the market.

Two other types of order that are commonly used for short-term trading strategies are fill or kill (FOK) and immediate or cancel (IOC). Fill or Kill (FOK) orders require that the order be immediately filled in its entirety. If this is not possible, the order is cancelled. FOK orders are used to find hidden liquidity. These orders are usually placed with small lots, and they cause small fluctuations at their level of depth of order books. Typically, FOK orders are repeated with progressively increasing offers or progressively decreasing bids, to cause shifts in order book prices by triggering hidden orders to respond. The level of price shift caused by FOK provides the FOK algorithm with estimates for both the aggressiveness of hidden orders and their sizes. Unless an exchange limits traders' order/fill ratios, they can be flooded with FOK orders causing gaps in their order books, an event that is referred to as order book fragmentation. Immediate or Cancel (IOC) orders require that any part of an order that can be filled immediately is filled, and any remaining shares are cancelled. IOC orders are typically used for pyramiding up and down in the order book both to attract aggressive market orders as well as discovering and exploiting hidden liquidity in the order book. Similar to FOK orders, IOC orders can flood markets unless exchanges impose order/fill ratios on their issuers. Other common types or orders that use market microstructure information include marketable limit orders, stop orders, stop limit orders, and trailing stop orders which include various mechanisms for switching between order types and attempts at minimizing losses when market conditions become unfavorable for the type of order that is used.

Saw tooth and accordion effects in price variations and high order placement and cancellation activity, are typical indications of high frequency trading activity. These effects include progressive price and volume shifts at lowest bids and highest asks, these bids and asks increasing or decreasing further in small increments, followed by prices leveling off. The types of algorithms that are active during such periods are pinging and guerilla algorithms that try to locate hidden orders and then lure the hidden orders' iceberg algorithms to transact with them via price pyramiding, before taking contrarian positions on these orders. The pinging and guerilla algorithms often include combinations of FOK and IOC orders. Multiple pinging and guerilla algorithms are often active concurrently in high volume and high liquidity markets. Hence, discerning the impact of specific algorithms from empirical observations of market data is difficult. Some trading firms developed data mining algorithms that try to discern specific patterns in historical order book data, and reverse engineer the behavior of competitors' algorithms, so that their own pinging and guerilla algorithms can outrun competitors' algorithms. Such extreme market analyses are bound to deliver little, if any, improvement for algorithms' performances. High pinging and guerilla activity usually causes temporary increases in the bid ask spreads in order books. Oftentimes, the bid/ask fluctuations caused by this activity lasts only for a few ticks, and is perceived as noise by slower trading systems.

Large institutional orders that are placed as hidden orders are often dissected in smaller orders and placed in order books via Volume Weighted Average Price (VWAP) or Time Weighted Average Price (TWAP) algorithms. These orders usually cause the reverse of the effect of pinging and guerilla algorithms in the order book. VWAP and TWAP algorithms typically try entering the order book at best possible price (bids or asks). They often include price trailing futures to improve their chances of execution. Consequently, TWAPs and VWAPs that prioritize on execution cause laddered waterfall effects within the order book. This can cause temporary contractions in bid ask spreads in order books.

While tracking market dynamics with VWAP and TWAP, price points for market entry are often estimated by implementation shortfall algorithms. An implementation shortfall algorithm focuses on capturing the best price for execution, and attempts at forecasting the longevity this waterfall activity for best market entry. If the implementation shortfall algorithm is aggressive in terms of time horizons for execution, the algorithm will give up a percentage of its price objective, and will try to position its orders at the second or third levels of the waterfall (and their corresponding positions in level 2 order book), thereby operating like a trailing algorithm. If the algorithm persists in avoiding shortfalls, then it will focus on executing within the first ladder of the hidden order's waterfall, thereby risking non execution if the waterfall shifts further away while the algorithm takes action. Obviously, to guarantee its chances of execution, the implementation shortfall algorithm often decreases its order size in order to generate a match.

Orders displayed in order books are getting increasingly smaller, as larger orders are sliced in smaller orders to reduce market impact. Trading strategies typically include dynamic adjustments of market entry and exit triggers to achieve minimum implementation shortfall within the order book while minimizing market impact. Therefore, large trading volumes may not always translate in abundance of liquidity, since such order slicing, along with the impact of sub penny rule, causes vertical fragmentation in order books, causing temporary price gaps, and consequently rapid price shifts in the order book. Trade execution strategies focus on price capture while minimizing market impact and implementation shortfall. Lot sizes are dynamically adjustable to minimize market impact according to the latest level 2 order book information. Lot sizes are also adjusted to secure a high probability buyers or sellers, therefore minimizing implementation shortfall. For contracts with high trading volumes, hidden orders can often exceed half of an order book's size. Hence, although level 2 order book provides useful information about the bid and ask range and volumes for openly placed orders, a trading strategy needs to take into account the effect of potential hidden orders to calibrate its bid and ask triggers.

It is common practice to capture volume, price, liquidity, volatility patterns, types of trades and the relationships among these factors in analytical formulas that are derived from empirical observations. For relatively longer time horizons, these analytical models enable the formulation of generic trading strategies that are applicable across markets, diverse ranges of price and volume in these markets, and time horizons where these trading strategies are applicable. These analytical models are often based on assumptions that market dynamics can be approximated by specific types of stochastic processes. A market dynamics model can include different stochastic process approximations for order arrivals at different levels of order books, order cancellation patterns, price formation and price series, and selection mechanisms for trading strategies and the patterns of algorithms that traders of automated systems invoke during trading.

The benefits of these analytical or semi analytical models are dependent on the validity of the analytical model over the time regime it is used. For example, for a relatively slow market that generates about a dozen ticks a minute, analytical models that capture these metrics for intraday observations over long calendar periods could prove useful. Such analytical models are used by chartists who attempt at extrapolating market patterns across their trading calendars, and set up either trend following or contrarian positions against these potential moves in the market. Similarly, trend followers who apply technical analysis to markets attempt at fine-tuning various market indicators to historical trends in the market. In this respect, they are similar to chartists. However, they attempt less at predicting the market but more at reacting to market changes at the right time and place with appropriately sized orders.

The literature on market microstructure exhibits a heavy emphasis on using econometrics models for modeling and forecasting order book dynamics. These are closed formed analytical models, typically in the form of stochastic differential equations. These equations are parameterized to provide ranges of changes in order book content for:
1. bid/ask prices and volumes for each price range;
2. execution rates for market order and their impact of the order book;
3. the correlation between the persistence of volatilities of price, liquidity patterns, and execution volumes across different time horizons (second, minutes, hours, intraday, and longer periods);
4. impact of hidden orders, where hidden orders are defined as the large orders that are submitted in small increments to minimize market impact (or price impact, as these terms are changed interchangeably);
5. the impact of block orders on price, liquidity and volume in the open market, as block orders are executed outside the open market, either through one-to-one matching between buyers and sellers, or by aggregating them in buy and sell order books that are crossed at specified auction times. If block order bids don't satisfy some buyers or sellers, these orders typically impact the open market as hidden orders.

Issues with econometrics models are as follows:
1. These parameters are fine-tuned according to specific market metrics Order book dynamic are modeled and estimated accordingly within the assumptions of the econometrics models and the confines of their market metrics.
2. Econometrics models lead often to over parameterized models that have little bearing on the dynamics of the market. Consequently, their fine-tuning becomes increasingly difficult and error prone, since the interplay among market metrics is often oversimplified in the underlying assumptions of these models.
3. Due to their closed form solutions, it is difficult to aggregate order book dynamics across multiple contracts by using econometrics models. Although extensive portfolio models exist for trading multiple contracts across multiple order books, effective econometrics models that integrate critical information such as volatility, liquidity, and other order book dynamics across multiple contracts are still lacking.

When trading time horizons become short, such as few ticks, and trading strategies depend on full order book information and the dynamics of the order book, then strategies are considered to depend on market microstructure. Analytical formulations for volume, price, liquidity and volatility dynamics break down at market microstructure. Thus, either new analytical formulations are attempted for market microstructures, or empirical observations are structured in quasi analytical and partially numerical models as “stylized facts.” Stylized facts are mostly effective when used as estimators of asymptotic behavior of market microstructure dynamics. They typically provide a first-order approximation to market behavior against which a trader can validate the feasibility of trading, given these asymptotic approximations to market dynamics and the latency profiles of the market.

Signal processing techniques are also used for tracking and acting on information on liquidity, price, volume and volatility. These techniques attempt at tracking the relative strengths of frequency components of market signals, including liquidity, volume and price, and use this information to estimate market trends, and trigger trading signals according to these estimates. These estimates include the potential for persistence of a market trend and the estimate of the time horizon for this trend to persist.

Prior art's delivery of market data analytics, estimations for market dynamics, risk metrics, feeds of algorithms such as VWAP and TWAP are fragmented according to the focus of the trading function such as buy side or sell side; trading frequencies; choices of mathematical or heuristic tools that are used in devising trading algorithms, such as technical indicators, neural nets, signal processing; the types of market data used for trading decisions; assumptions made about the mathematical models for market dynamics, ensuing assumptions used in devising trading algorithms, and in formulating stylized facts and the trading regimes of effectiveness for these stylized facts. Such fragmentation leads to designs and trading algorithms with narrowed ranges of taxonomies of trading strategies, trading frequencies and types of markets where these algorithms can be utilized.

### SUMMARY OF THE INVENTION

It is therefore an object of the present invention to present an improved method and apparatus for tracking, storing and disseminating market microstructure information in terms of metrics that traders can directly integrate with their trading algorithms. The invention's algorithms-as-feeds will cover trading frequencies ranging from microseconds to hours within a single tool that is readily adaptable to users' existing trading systems. The present invention will deliver a consistent data structure, and software and hardware architecture for its algorithm feeds from all of its markets, including exchanges, alternative trading facilities, over-the-counter (OTC) trading platforms, and dark pools across different asset classes, to enable correlated high-precision trading across multiple markets simultaneously. The invention is the first appliance to provide of ticker plants of not just market data feeds but feeds of data analytics and algorithms that are integrated with market data as a cohesive trading tool.

The invention's baseline functional construction methods provide mathematically consistent numerical characterization of its market microstructure data feeds across all of its multiple time horizons, thereby delivering a coherent tool to devise, test and calibrate trading strategies to operate at different trading frequencies by using the invention's modules that include the generation of market microstructure analytics data, the ticker plant to aggregate and synchronize these microstructure analytics feeds across multiple markets, the market simulation and trading strategy calibration utilities that enable traders to build and test trading strategies using these feeds.

### BRIEF DESCRIPTION OF THE DRAWINGS

The accompanying drawings illustrate the invention, Market Microstructure Data Appliance (MMDA), in a form that is presently presented. It is being understood, however, that the invention is not limited to the specific arrangements and their instrumentalities as depicted in these drawings. The features and ensuing advantages of the present invention will become apparent from the description of the invention that refers to these drawings:

FIG. 1 is a generic diagrammatic depiction of MMDA and its modules according to the present invention showing various components thereof.

FIG. 2 illustrates MMDA's interface with markets and its functional units for processing of market data.

FIG. 3 illustrates the architecture of MMDA's market interface.

FIG. 4 illustrates the implementation MMDA's market data pre-processing as a low pass filter.

FIG. 5 is the block diagram of the moving average computation, one of MMDA's analytics.

FIG. 6 is a block diagram of time windows for moving average and that is replicated for other analytics.

FIG. 7 is a block diagram of the derivation of market microstructure data feeds from market data.

FIG. 8 is a block diagram of MMDA's functional units for generating market microstructure data.

FIG. 9 is a generic diagrammatic depiction of MMDA's ticker plant.

FIG. 10 illustrates the interaction of the market simulator with real and simulated market data feeds.

FIG. 11 illustrates the functions of trading agents, matching engines and their interaction within the market simulator.

FIG. 12 illustrates the taxonomy of trading strategies and algorithms that can be constructed, tested and calibrated by using MMDA.

FIG. 13 illustrates the feedback control loop of market metrics, risk metrics, market estimation, risk assessment trade logic calibration, and coherent event and data coordination across this loop.

FIG. 14 illustrates the training of the Rete algorithm in trading agents' logic in the market simulator.

FIG. 15 illustrates iterative calibration of trading algorithms with market simulation.

FIG. 16 depicts the use of baseline publish and subscribe technologies across MMDA.

FIG. 17 illustrates the object structure of MMDA's functions and its mapping to a pointer-based architecture.

### DESCRIPTION OF PREFERRED EMBODIMENT

The present invention, Market Microstructure Data Appliance (MMDA), will now be described more fully thereafter with reference to the accompanying drawings, in which a preferred embodiment of the invention is presented. However, this invention may be embodied in many different form, and therefore, it should not be construed as limited to the precise arrangements and embodiment set forth herein. Rather, this embodiment is provided so that the disclosure will be thorough and that it will present fully the scope, the features and advantages of the invention.

1. The Components of the Invention

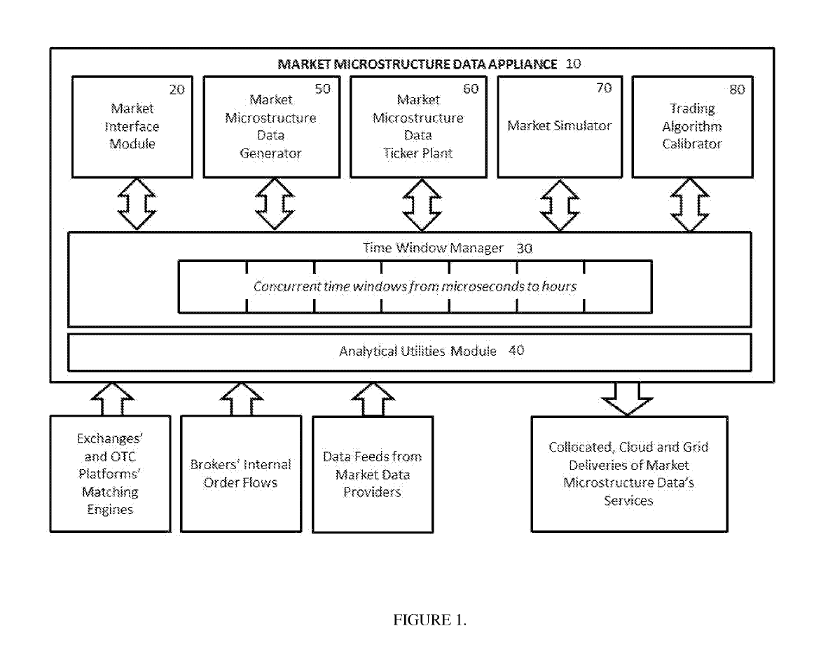

Referring now to FIG. 1, a functional block diagram of the modules of MMDA 10 is shown. The term module refers to one or more components of MMDA that include software elements and hardware elements, including the implementations of functions, algorithms, classes and the like that contribute to the efficient operation of each module and the overall effectiveness of the MMDA 10.

The appliance includes seven modules: the Market Interface Appliance (MI) 20 for interfacing MMDA with market data feeds; the Analytical Utilities Module (AU) 30 that provides the baseline mathematical and heuristic algorithms and their software and hardware deployments for all the modules for MMDA; the Time Windows Manager (TW) 40 for cohesive time stamping of market microstructure data, and dynamic time window management across MMDA's appliance; the Market Microstructure Data Generator (MG) 50; the Market Microstructure Ticker Plant (TP) 60; the Market Simulator (MS) 70; the Trading Algorithm Calibrator (AC) 80.

MI 20 maps the order types, order sequencing and order matching rules of exchanges to MG 50, and enables MG's operating parameters to process each exchange according to its specific set of market characteristics. AU 30 provides the baseline functions for linear algebra, sparse and dense matrix processing, data structure libraries, parallel and concurrent processing algorithms, distributed processing algorithms, load balancing algorithms. TW 40 generates concurrently market microstructure analytics feeds across different time windows ranging from microseconds to hours. Each time window includes an adjustable number of data points for each market microstructure data feed. MG 20 complements current market data feeds from electronic trading platforms with concurrent market microstructure data feeds that MG 20 derives from these platforms' market data feeds. These feeds include market estimates, risk metrics, and mathematical and heuristic building blocks of trading algorithms. TP 60 consolidates and synchronizes market microstructure data feeds that are provided by MG 50 from multiple markets into ticker plants. TP 60 time-stamps market data analytics from multiple markets with their underlying market data feeds at high levels of time granularity. AC 80 enables traders to validate and calibrate the mathematical and heuristic assumptions that are implemented in their trading algorithms against market microstructure feeds that that are generated by MMDA without any prior assumptions about market behavior.

All the modules of the appliance integrate the following core mathematical, heuristic and software tools:
1. numerical reconstruction of signals from their statistical moments over dynamic time windows;
2. overlaying data streams and analytics derived from these streams as synchronized analytics feeds;
3. real time inductive reasoning and iterative learning over these streams;
4. tracking signals' error margins across the systems and initiating corrective action via feedback control;
5. concurrent and distributed publish and subscribe middleware to operate the appliance.

2. Market Interface Module (MI)

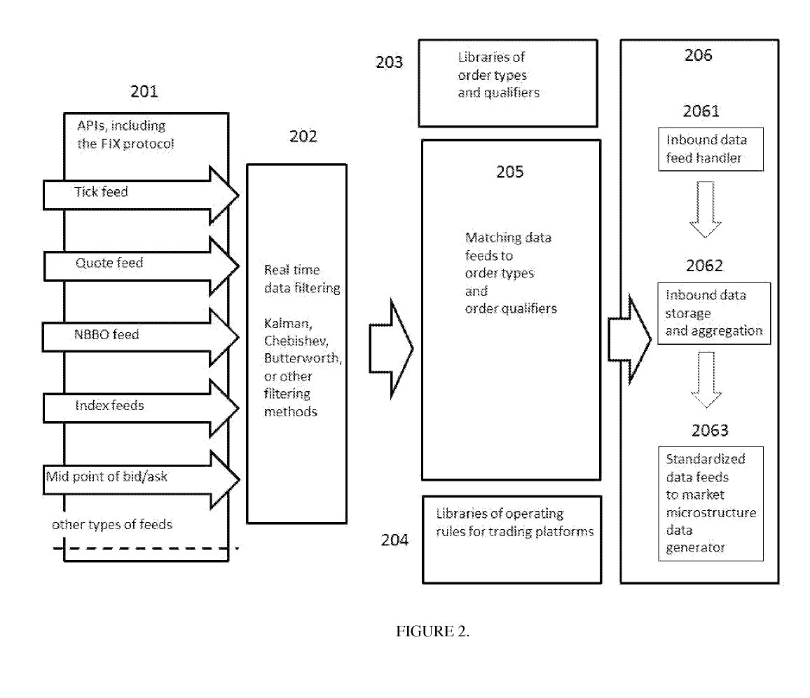

Referring now to FIG. 2, MMDA's front end includes the market interface appliance (MI) module that maps order types, order sequencing and order matching rules of exchanges to MMDA, and that enables MMDA operating parameters to process each exchange according to its specific set of market characteristics. MI captures market data feeds from electronic exchanges and transforms these feeds for processing by MMDA.

MI can be connected to exchanges' matching engines or market data feed services via its application programming interfaces (APIs) 201, including the Financial Information Exchange (FIX) protocol. MI can be deployed to be agnostic to the specific protocols and hardware features of the API, thereby enabling API's architecture with a long-term utility cycle and ease-of-reconfigurability for evolving API technologies.

MI filters the incoming data through its filter unit 202 to remove noise of various origins by using well-known filtering techniques, including and not limited to low pass filtering with Kalman, digital Butterwoth or digital Cebyshev filters that can be used in interchangeably in different embodiments of the invention, according to desired levels of filtering accuracy, targeted levels of relative error margins, and required processing speeds of incoming data. Software or hardware implementations of these filters will depend on the required Nyquist sampling rates as functions of data throughput rates of trading platforms that are being tracked.

MI includes libraries of order types, order qualifiers, order execution and matching rules as shown in block 203 for the exchanges where MMDA is deployed. The filtered data feeds are matched with these libraries and against libraries of operating rules of trading platforms as depicted in block 204. This matching function enables the MG to estimate order flow features such as hidden orders, cancels of quotes, flows of market orders, ticks due to matches of different order types, including limit, market, stop, FOK, IOC, the effective spread of the limit order book. This pre-processing of market data by MI enables MMDA to generate MMDA analytics independently of the specific operating requirements of the exchange whose data is processed.

The received market data will be processed and stored in structures that accommodate data from all data feed types at MI's output stage 206. If the downstream processing requires data different from the available feed, and the required data is derivable, the required data will be calculated. Data is received from market data interfaces and presented to the MI internal processing as an event. Data is passed through the software as smart-pointers to the underlying types. A single event is created to represent each received message from the market data interface. Events are represented as instances of objects within the MI software.

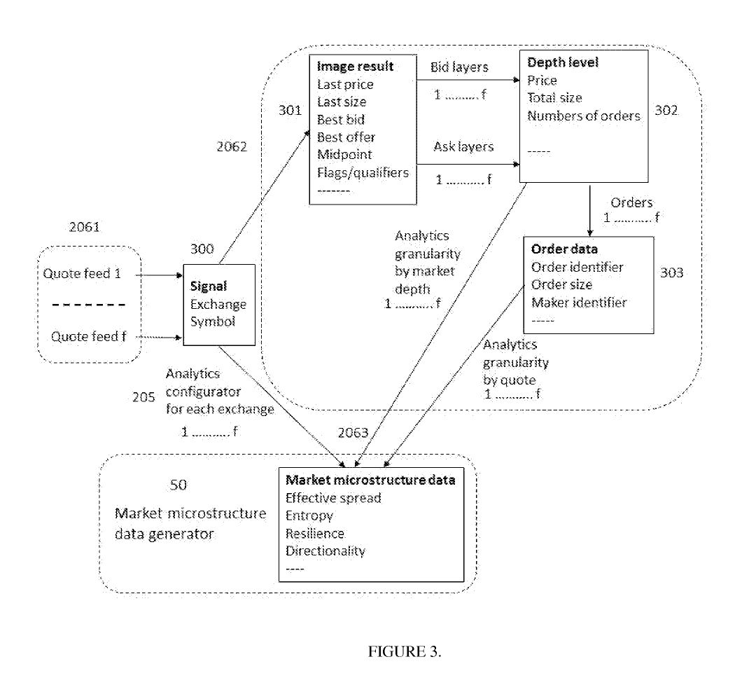

Referring now to FIG. 3, trade and quote events are handled by event handlers 2061 within MI's output block. The open architecture allows for new market data sources to be added for providing additional feed types. Further event handling can be added event handling for those types.

The processing of the data feeds includes synchronization, initial processing and storage of the inbound data into a structure that is accessible to all downstream processing. This processing and storage unit 2062 is within MI's output block. This common structure contains not only the inbound data but results of processing the data as well. The inbound data events are queued until the data feed handler can process it. If more than a single inbound event has arrived before the feed handler begins processing, the set of messages is processed together. This is done by processing the entire contents of the inbound queue to start the processing. No processing is performed unless there is at least one inbound event to process. This results in asynchronous processing since the interval between events that are propagated downstream from the input processing is non-deterministic. When inbound data arrives faster than the inbound processing, then the events are propagated at a rate proportional to the processing rate. This is not constrained to be a steady (or synchronous) rate. When the inbound data arrives slower than it is processed, then the events are propagated at that non-steady rate.

The aggregation of inbound data in storage unit 2062 which depicts the case of multiple quote feeds from different trading platforms. The signal information contains an image of the inbound data. This is where the different data types are stored alongside each other. For the current trade data feed, this includes the current price and quantity (size) of the inbound trade event. Each element of the market depth lists represents the aggregate orders at a specific layer of the order book at the time of the data event.

The inbound queue is taken and is split into events for each inbound signal and each signal is then processed to establish the inbound data values. For the case of quote feeds, this process delivers images of each limit order book that is depicted in block 301, and the updated market depth information for each limit order book image as shown in block 302, and order information for each quote as depicted in block 303 across each symbol feed.

Feeds for best bid-offer and midpoint data, and similar market structure feeds are added as peers of the price and size data currently held in the structure 301. Boolean flags indicating the presence of specific inbound data are included as well. Each element of the market depth lists represents the aggregate orders at a specific layer of the order book at the time of the data event. This information includes the price of the layer, the aggregate quantity of orders at that layer, and the number of orders at that layer as part of block 302. The position of these elements in the list represents the order book layer identifier whereby index 0 is top of book, and index 3 is the fourth (counting from 1) order book layer in block 303. If a quote data feed is present and desired for downstream processing, an additional link from each order book layer element references a set of individual orders. Each individual order will contain an order identifier and a quantity. If the data feed provides a market maker, the identifier of the originator of the order can be included as well in block 303.

The results are then passed to Market Microstructure Data Generator (MG) 50 as shown by data flow block 2063. MG then queues a copy of the current state of the market data and derivative information for use by MG's utilities. Inbound stream is separated into individual streams for each signal. All available events are thus combined and filtered. Depending on the configuration of DMMA, MG's market microstructure data feeds can be updated on either market depth or quote events, or both.

Market microstructure data from MG are included within the signal result structure as a peer of the signal image information. The analytics also include a set of flags indicating which of the possible analytic results are included in the resulting structure. Only those results that are required by downstream processing are calculated.

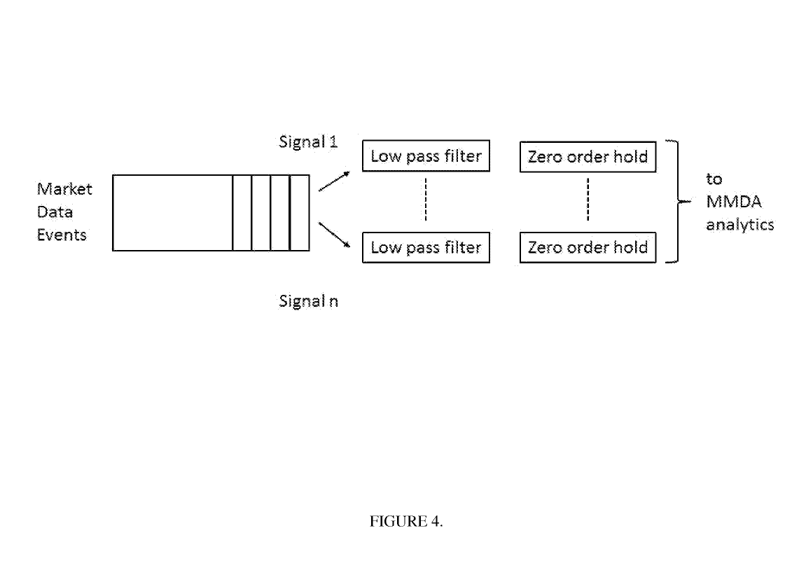

Analogous aggregation processing is done with each inbound market data event type including trade, depth, quote, BBO, midpoint of bid-ask, etc. If no events for a signal are received at the start of processing for each event, then the current embodiment of the invention uses the previous value will be used and passed downstream as if it had been received. As shown in FIG. 4, this is the equivalent of a zero-order hold filter on the input stream for that signal. The aggregation operation is the equivalent of a low pass filter, and the sampling rate is the same for all the signals. In addition to the aggregation calculations, additional inbound data processing can occur at this point in the data flow such as rejection of outliers. Relative error calculations are performed at this point to track market data feed inaccuracies. The zero-order hold filter can be replaced by other synchronous or asynchronous data filtering and extrapolation methods for higher accuracy while keeping the data aggregation functionality intact.

3. Time Windows Manager (TW)

TW module 30 as shown in FIG. 1, enables data across large time windows while minimizing memory requirements for dynamic data storage across MMDA. TW uses simple scaling and compression formulas for dynamic window management and storage of data streams to minimize the computational effort for data management. Thus, TW accommodates orders of magnitude differences in frequencies of market signals (such as quotes, limit order placements, and ticks) for each symbol. Each market signal is tracked and stored in dynamic arrays. The tracking and storing logic is devised to provide the balance for the precision to be provided to trading logic for the immediate past time points of signal arrivals, and for minimizing memory requirements for storing data dynamically.

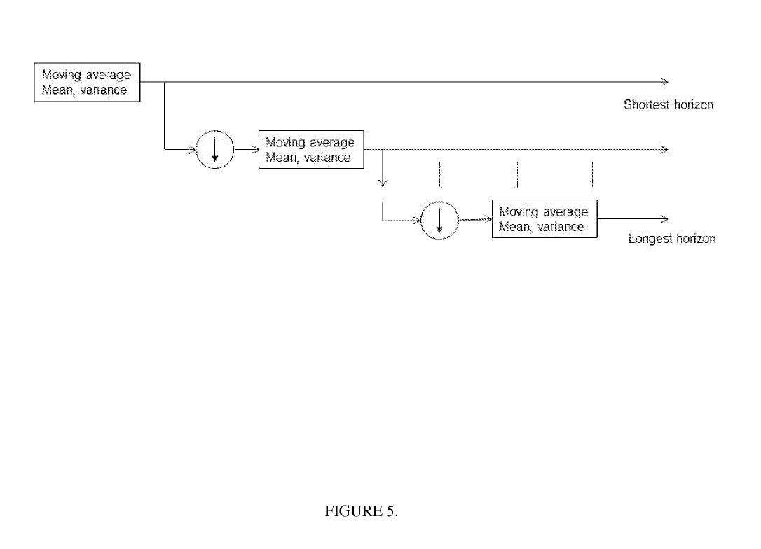

TW provides a multi stage data path pipeline for processing market data from exchanges and market microstructure analytics data concurrently across multiple time windows covering time ranges of microseconds to hours. Each time window includes an adjustable number of statistically significant data points for each microstructure data feed. TW provides for logarithmic scaling of data sets across time partitions, thereby providing for concurrent processing of market microstructure analytics within time horizons that range from microseconds to hours. As depicted in FIG. 5, using moving averages is one of the many possible implementations of such successive refinements for down streaming across multiple time horizons.

In the following, an arrangement for time window management for the current embodiment of the invention is presented. The parameter L is a real multiple of the minimum of number of arrivals of market data from market data interface, or arrivals of market microstructure data feeds that are derived from market data by the market microstructure data generation module (MG).

```
{ Parameters}
Let:
L be the size each sub array;
M be the number of sub arrays;
{Initialization; fill the first sub array}
  Fill the first sub array with the first L incoming data points.
{Fill the first entry of the second sub array}
  For the next arriving L data points, do the following:
  For 1 ≦ j ≦ L;
      Compute the mean of j most recent points and the last L−j data points of the first sub array;
      Store this mean value at the first entry of the second sub array;
      Update this mean value for each new arrival of data;
      Increment j by 1: j = j + 1;
{Extension of the fill logic for the first entry of the second sub array to any entry the second sub array}
  For each entry k of the second sub array with 1 ≦ k ≦ L;
    For 1 ≦ j ≦ L;
          Compute the mean of j most recent points and the last L−j data points of the first sub array;
          Store this mean value at the k'th entry of the second sub array;
          Update this mean value for each new arrival of data;
          Increment j by 1: j = j + 1;
  Increment k by 1:k =k + 1;
{Fill logic for any entry of any sub array following the first one}
  For each sub array m; 2 ≦ m ≦ M;
    For each entry k of the n'th sub array with 1 ≦ k ≦ L;
          For 1 ≦ j ≦ L;
              Compute the mean of j most recent points and the last L−j data points of the n−1'st sub array;
              Store this mean value at the k'th entry of the m'th sub array;
              Update this mean value for each new arrival of data;
              Increment j by 1: j = j + 1;
    Increment k by 1: k =k + 1;
  Increment m by 1; m= m+1;
The M level arrays above are concatenated in a single array for each data feed.
```

4. Analytical Utilities Module (AU)

AU module 40 as shown in FIG. 1, provides the algorithms as software and hardware components of market microstructure data feeds. These components include computation of concurrent statistics, including mean, dispersion, variance, skewness, kurtosis, autocorrelation, and other mathematical algorithms, including wavelet decompositions, of market data from exchanges and for generating market microstructure analytics data across pipelines of multiple and dynamic time windows that are processed by the Time Windows Manager (TW).

For the purpose of illustrating the implementation of these algorithms, the computation of statistics over data series is described. Descriptive statistics can be defined using statistical moments for a sequence of N data values {xᵢ} as:

$$\begin{matrix}x = μ = {μ}^{′ ( 1 )} ; mean & ( 1.1 ) \\ {σ}^{2} = {μ}^{( 2 )} ; variance & ( 1.2 ) \\ γ = \frac{{μ}^{( 3 )}}{{σ}^{3}} ; skewness & ( 1.3 ) \\ κ = \frac{{μ}^{( 4 )}}{{σ}^{4}} - 3 ; kurtosis & ( 1.4 )\end{matrix}$$

The notation, μ^{r(k)} and μ^{(k)} are the raw (moments about 0) and central (moments about the mean) moments respectively. The parenthetical superscript indicates which moment is being referenced. Raw moments are defined as:

$$\begin{matrix}{μ}^{′ ( k )} = \frac{1}{N} {M}^{′ ( k )} ; raw moment & ( 2.1 ) \\ {M}^{′ ( k )} = {\sum }_{i = 1}^{N} {x}_{i}^{k} ; raw moment generator & ( 2.2 )\end{matrix}$$

Central moments are defined as:

$$\begin{matrix}{μ}^{( k )} = \frac{1}{N} {M}^{( k )} ; central moment & ( 2.3 ) \\ {M}^{( k )} = {\sum }_{i = 1}^{N} {( {x}_{i} - x )}^{k} ; central moment generator & ( 2.4 )\end{matrix}$$

Correlation can be defined as a joint statistical moment between two sequences {yᵢ}, {zᵢ} as:

$${ρ}_{y , z} = \frac{{covar}^{( y , z )}}{{σ}_{y} {σ}_{z}} ; correlation \qquad ( 3.1 )$$

The notation covarz^{(y,z)} is the second joint moment between the two data sequences and is defined as:

$$\begin{matrix}{covar}^{( y , z )} = \frac{1}{N} {C}^{( y , z )} ; covariance & ( 3.2 ) \\ {C}^{( y , z )} = {\sum }_{i = 1}^{N} ( {y}_{i} - y ) ( {z}_{i} - z ) ; covariance generator & ( 3.3 )\end{matrix}$$

From equations (1.1) through (3.3), the descriptive statistics can be generated completely from values for the generator functions, which are summations over the input data sequence(s). The above equations assume the entire data set is used to generate the descriptive statistical values. To indicate the data used for a set of generated values a subscript is added to the equations to indicate where the subset is located in the input sequence. The extended equations below use subscripts n as the most recent data value and l (lower) as the least recent data value included to generate the statistical values for the data subset. This means that the input sequence data used is [l,n]. The amount of data in the window can also be derived from the subscripts as:

N=n−l+1; amount of data in the window (4)

The following equations can be used to calculate a value for each generator function at any window. These can then be used in the equations above to determine the value of any desired descriptive statistic at any window of the input sequence data.

$$\begin{matrix}{x}_{n} = {μ}_{n}^{′ ( 1 )} = \frac{1}{N} {M}_{n}^{′ ( 1 )} ; expected value & ( 5.1 ) \\ {M}_{n}^{′ ( k )} = {\sum }_{j = l}^{n} {x}_{j} ; raw moment generator & ( 5.2 ) \\ {M}_{n}^{( k )} = {\sum }_{j = l}^{n} {( {x}_{j} - {x}_{n} )}^{k} ; central moment generator & ( 5.3 ) \\ {C}_{n}^{( y , z )} = {\sum }_{j = l}^{n} ( {y}_{j} - {y}_{n} ) ( {z}_{j} - {z}_{n} ) ; covariance generator & ( 5.4 )\end{matrix}$$

To generate the descriptive statistical values efficiently, the invention uses recursive formulas to add and remove data values from previously calculated values. These formulas are derived from the public domain document titled: Formulas for Robust, One-Pass Parallel Computation of Covariances and Arbitrary-Order Statistical Moments, Philippe Pebay, Sandia National Laboratories, 2008. This approach means that a simple add (or remove) calculation is all that is required to create the generator function value, which can then be used to create the desired result directly. This requires retention of the previous generator function value; this storage cost is offset by the time it would take to recalculate the summations over the entire data subset. Also, since the windows overlap, the same summation terms do not need to be recalculated for each window that contains the overlapping portion of the data subset. The equations for the mean (μₙ^{r(1)}) and central moments (Mₙ^{(k)},C^{y,z)}) are:

$$\begin{matrix} {μ}_{0 , x}^{′ ( 1 )} = {M}_{0 , x}^{( k )} = {C}_{0}^{( y , z )} = 0 ; initial conditions & ( 6.1 ) \\ {δ}_{n , x} = {x}_{n} - {μ}_{n - 1 , x}^{′ ( 1 )} & ( 6.2 ) \\ {μ}_{n , x}^{′ ( 1 )} = {μ}_{n - 1 , x}^{′ ( 1 )} + \frac{{δ}_{n , x}}{n} & ( 6.3 ) \\ {M}_{n , x}^{( 2 )} = {M}_{n - 1 , x}^{( 2 )} + {δ}_{n , x}^{2} \frac{n - 1}{n} & ( 6.4 ) \\ {M}_{n , x}^{( 3 )} = {M}_{n - 1 , x}^{( 3 )} + {δ}_{n , x}^{3} \frac{( n - 1 ) ( n - 2 )}{{n}^{2}} - 3 {δ}_{n , x} \frac{{M}_{n - 1 , x}^{( 2 )}}{n} & ( 6.5 ) \\ {M}_{n , x}^{( 4 )} = {M}_{n - 1 , x}^{( 4 )} + {δ}_{n , x}^{4} \frac{( n - 1 ) ( {n}^{2} - 3 n + 3 )}{{n}^{3}} + 6 {δ}_{n , x}^{2} \frac{{M}_{n - 1 , x}^{( 2 )}}{{n}^{2}} - 4 {δ}_{n , x} \frac{{M}_{n - 1 , x}^{( 3 )}}{n} & ( 6.6 ) \\ {C}_{n}^{( y , z )} = {C}_{n - 1}^{( y , z )} + \frac{n - 1}{n} {δ}_{n , y} {δ}_{n , z} & ( 6.7 )\end{matrix}$$

By solving the above equations for the values at the previous index, formulas for removing a data value from the previous mean or central moment can be derived:

$$\begin{matrix} {μ}_{n - 1 , x}^{′ ( 1 )} = \frac{n {μ}_{n , x}^{′ ( 1 )} - {x}_{n} }{n - 1} & ( 7.1 ) \\ {M}_{n - 1 , x}^{( 2 )} = {M}_{n , x}^{( 2 )} - ( {x}_{n} - {μ}_{n - 1 , x}^{′ ( 1 )} ) ( {x}_{n} - {μ}_{n , x}^{′ ( 1 )} ) & ( 7.2 ) \\ {M}_{n - 1 , x}^{( 3 )} = {M}_{n , x}^{( 3 )} - {δ}_{n , x}^{3} \frac{( n - 1 ) ( n - 2 )}{{n}^{2}} + 3 {δ}_{n , x} \frac{{M}_{n - 1 , x}^{( 2 )}}{n} & ( 7.3 ) \\ {M}_{n - 1 , x}^{( 4 )} = {M}_{n , x}^{( 4 )} - {δ}_{n , x}^{4} \frac{( n - 1 ) ( {n}^{2} - 3 n + 3 )}{{n}^{3}} - 6 {δ}_{n , x}^{2} \frac{{M}_{n - 1 , x}^{( 2 )}}{{n}^{2}} + 4 {δ}_{n , x} \frac{{M}_{n - 1 , x}^{( 3 )}}{n} & ( 7.4 ) \\ {C}_{n - 1}^{( y , z )} = {C}_{n}^{( y , z )} - \frac{n - 1}{n} {δ}_{n , y} {δ}_{n , z} & ( 7.5 )\end{matrix}$$

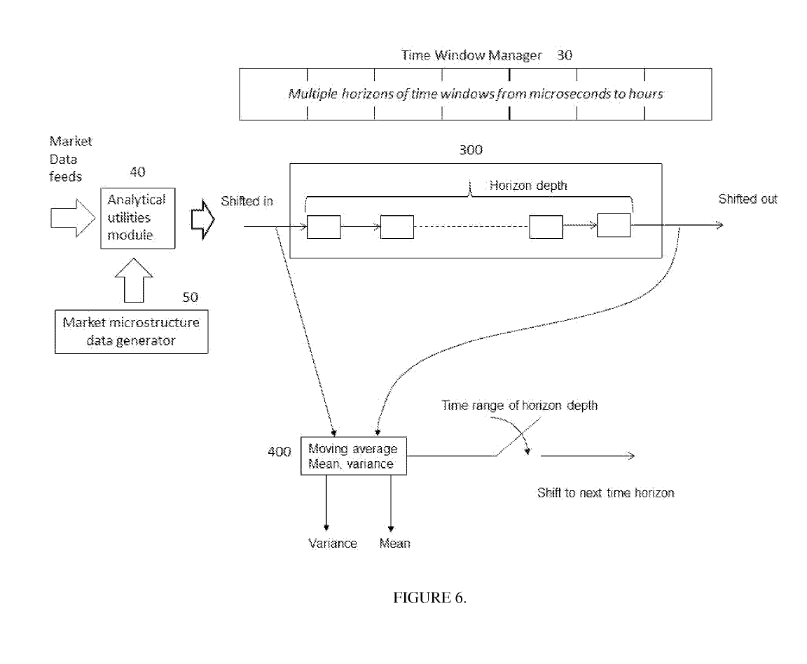

Referring now to FIG. 6, the functional block diagram of computing analytics over time horizons is shown. The functional block 300 depicts one the time horizons of the Time Window Manager (TM) 30 from FIG. 1. The horizon depth of block 300 is the size of data array that is allocated for this specific time horizon. Depths of horizons need not be equal. Analytical Utilities Module (AU) 40 from FIG. 1 processes both feeds from markets and market microstructure analytics that Market Microstructure Data Generator derives from feeds from markets. These two feeds from AU 40 are forwarded each sequentially to TM 30, whereby block 300 shows the processing of such data within a given horizon. Functional block 400 depicts the storage of this additional statistical data alongside with the baseline data feeds from market data feeds and from MG 50.

The implementation creates a configurable number of time horizons and statistics for each metric over each time horizon. Each time horizon processes the average value of the previous horizon down sampled to one input to the next time horizon from the previous time horizon simple moving average length. This down sampling reduces both the noise and the amount of data to be processed. Equations (8.1) through (8.7) below describe AU 50's implementation of mean and variance computations across data series that are processed by TW 30 over concatenated time horizons.

To add data to time horizon (h⁽ⁱ⁾) where n is the sample number:

$$\begin{matrix}{}_{}^{{h}^{( i )}}{δ}{}_{n}^{} = {x}_{n} - {}_{}^{{h}^{( i )}}{x}{}_{n - 1}^{} & ( 8.1 ) \\ {}_{}^{{h}^{( i )}}{x}{}_{n}^{} = {}_{}^{{h}^{( i )}}{x}{}_{n - 1}^{} + \frac{{}_{}^{{h}^{( i )}}{δ}{}_{n}^{}}{N} ; where N = {depth}_{{h}^{( i )}} & ( 8.2 ) \\ {}_{}^{{h}^{( i )}}{σ}{}_{n}^{2} = {}_{}^{{h}^{( i )}}{σ}{}_{n - 1}^{2} + {}_{}^{{h}^{( i )}}{δ}{}_{n}^{2} \frac{N - 1}{N} & ( 8.3 )\end{matrix}$$

and to remove data from time horizon (h⁽ⁱ⁾):

$$\begin{matrix}{}_{}^{{h}^{( i )}}{x}{}_{n - 1}^{} = \frac{{N}^{{h}^{( i )}} {x}_{n} - {}_{}^{{h}^{( i )}}{x}{}_{n}^{}}{N - 1} & ( 8.4 ) \\ {}_{}^{{h}^{( i )}}{σ}{}_{n - 1}^{2} = {}_{}^{{h}^{( i )}}{σ}{}_{n}^{2} - {}_{}^{{h}^{( i )}}{δ}{}_{n}^{2} \frac{N - 1}{N} & ( 8.5 )\end{matrix}$$

When calculating a set of time horizons, the data flows through from the output of one horizon to the input of the next. This is shown in equation (8.6) below:

h⁽⁰⁾ is horizon 0 and n is the inbound sample number.

^{h}^{⁽⁰⁾}x_{n, wide} and ^{h}^{⁽⁰⁾}σ_{n, wide}² are intermediate results for a larger moving average.

$${h}^{( 0 )} = ( \begin{matrix}{}_{}^{{h}^{( 0 )}}{δ}{}_{n}^{} = {x}_{n} - {}_{}^{{h}^{( 0 )}}{x}{}_{n - 1}^{} \\ {}_{}^{{h}^{( 0 )}}{x}{}_{n , wide}^{} = {}_{}^{{h}^{( 0 )}}{x}{}_{n - 1}^{} + \frac{{}_{}^{{h}^{( 0 )}}{δ}{}_{n}^{}}{{depth}_{{h}^{( 0 )}}} \\ {}_{}^{{h}^{( 0 )}}{σ}{}_{n , wide}^{2} = {}_{}^{{h}^{( 0 )}}{σ}{}_{n - 1}^{2} + {}_{}^{{h}^{( 0 )}}{δ}{}_{n}^{2} \frac{{depth}_{{h}^{( 0 )}} - 1}{{depth}_{{h}^{( 0 )}}} \\ {}_{}^{{h}^{( 0 )}}{x}{}_{n}^{} = \frac{{depth}_{{h}^{( 0 )}} {}_{}^{{h}^{( 0 )}}{x}{}_{n , wide}^{} - {}_{}^{{h}^{( 0 )}}{x}{}_{n - {depth}_{{h}^{( 0 )}}}^{}}{{depth}_{{h}^{( 0 )}} - 1} \\ {}_{}^{{h}^{( 0 )}}{δ}{}_{n - {depth}_{{h}^{( 0 )}}}^{} = {x}_{n - {depth}_{{h}^{( 0 )}}} - {}_{}^{{h}^{( 0 )}}{x}{}_{n}^{} \\ {}_{}^{{h}^{( 0 )}}{σ}{}_{n}^{2} = {}_{}^{{h}^{( 0 )}}{σ}{}_{n , wide}^{2} - {}_{}^{{h}^{( 0 )}}{δ}{}_{n - {depth}_{{h}^{( 0 )}}}^{2} \frac{{depth}_{{h}^{( 0 )}} - 1}{{depth}_{{h}^{( 0 )}}}\end{matrix} ) \qquad ( 8.6 )$$

For the second and subsequent horizons, the input data is the moving average of the mean value from the previous horizon. Only one sample for each depth samples from the previous horizon is used as input to the current horizon effectively down sampling the data stream. Each mean value used as input to a horizon is a multiple of the previous horizon depth. This can be seen from the calculations for the second horizon in equation (8.7) below:

i is the sample number for the current horizon h⁽¹⁾.

^{h}^{⁽¹⁾}x_{i, wide} and ^{h}^{⁽¹⁾}σ_{i, wide}² are intermediate results for a larger moving average.

$${h}^{( 1 )} = ( \begin{matrix}{}_{}^{{h}^{( 1 )}}{δ}{}_{i}^{} = {}_{}^{{h}^{( 0 )}}{x}{}_{i \times {depth}_{{h}^{( 0 )}}}^{} - {}_{}^{{h}^{( 1 )}}{x}{}_{i - 1}^{} \\ {}_{}^{{h}^{( 1 )}}{x}{}_{i , wide}^{} = {}_{}^{{h}^{( 1 )}}{x}{}_{i - 1}^{} + \frac{{}_{}^{{h}^{( 1 )}}{δ}{}_{i}^{}}{{depth}_{{h}^{( 1 )}}} \\ {}_{}^{{h}^{( 1 )}}{σ}{}_{i , wide}^{2} = {}_{}^{{h}^{( 1 )}}{σ}{}_{i - 1}^{2} + {}_{}^{{h}^{( 1 )}}{δ}{}_{i}^{2} \frac{{depth}_{{h}^{( 1 )}} - 1}{{depth}_{{h}^{( 1 )}}} \\ {}_{}^{{h}^{( 1 )}}{x}{}_{i}^{} = \frac{{depth}_{{h}^{( 1 )}} {}_{}^{{h}^{( 1 )}}{x}{}_{i , wide}^{} - {}_{}^{{h}^{( 0 )}}{x}{}_{( i - {depth}_{{h}^{( 1 )}} ) \times {depth}_{{h}^{( 0 )}}}^{}}{{depth}_{{h}^{( 1 )}} - 1} \\ {}_{}^{{h}^{( 1 )}}{δ}{}_{i - {depth}_{{h}^{( 1 )}}}^{} = {}_{}^{{h}^{( 0 )}}{x}{}_{( i - {depth}_{{h}^{( 1 )}} ) \times {depth}_{{h}^{( 0 )}}}^{} - {}_{}^{{h}^{( 1 )}}{x}{}_{i}^{} \\ {}_{}^{{h}^{( 1 )}}{σ}{}_{i}^{2} = {}_{}^{{h}^{( 1 )}}{σ}{}_{i , wide}^{2} - {}_{}^{{h}^{( 1 )}}{δ}{}_{i - {depth}_{{h}^{( 1 )}}}^{2} \frac{{depth}_{{h}^{( 1 )}} - 1}{{depth}_{{h}^{( 1 )}}}\end{matrix} ) \qquad ( 8.7 )$$

5. Numerical Functional Reconstruction over Dynamic Time Windows

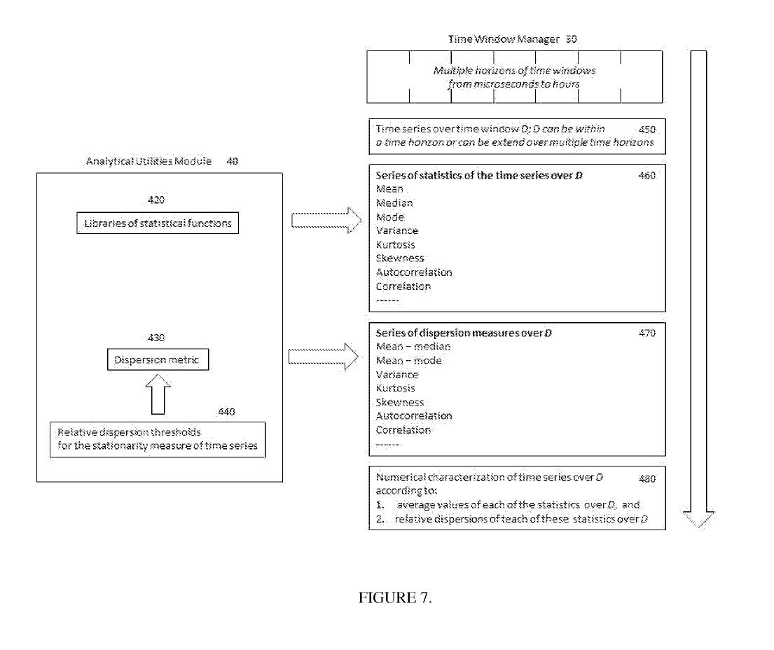

The invention extends the concurrent management of time series analytics over multiple horizons of market data series and market microstructure data series to higher other moments as depicted in equations (6.1) through (7.5) for numerical functional reconstruction whereby the probability distributions of these data series are estimated in real time and concurrently across these time horizons. In the present embodiment of the invention, these distributions are characterized by mean, mode, median, standard deviation, skewness and kurtosis of time series over data ranges that can be either be within each horizon of the Time Window Manager (TW) or over multiple horizons. The stationarity of the time series in these time horizons according to relative error margins of dispersions of mean and median; mean and mode; and dispersions of series of mean, standard deviation, skewness, kurtosis, autocorrelation; as well as correlations of market data series with indices, such S&P, for example. The current embodiment of the invention computes these dispersions and variations by using the z-score as a normalized measure for each of these statistics over these time series. Z-score is defined as:

$$z = \frac{x - μ}{σ} \qquad ( 9 )$$

where x is a data point of the time series within the data range where numerical functional construction will be applied. μ and σ are respectively the mean and the standard deviation of the time series within this range of data. The moment-based functional reconstruction in the current embodiment of the invention is representative of many different forms of numerical functional reconstruction over dynamic time windows. Referring now to FIG. 7, the current embodiment of the invention depicts the Analytical Utilities Module (AU) 40 of FIG. 1 as it provides the libraries of statistical functions as shown in functional block 420, the dispersion metric as shown in functional block 430, and the relative thresholds for the stationarity and dispersion measures of these time series as shown in functional block 440. The time series of length D shown in data block 450 whose statistics and dispersions are computed can be within a given time horizon of the Time Window Manager (TW) 30 of FIG. 1, these time series can overlap with several time horizons across TW.

AU's statistics libraries generate statistics series of the data series of length D as shown data block 460. AU's dispersion metric, which is the z-score in the invention's current embodiment, computes the dispersions of these statistics across D as shown in data block 470 according to the relative dispersion threshold in the functional block 440. The output of this computation provides the characterization of the data set of length D in terms of (i) its statistical moments, and (ii) the deviations of its mean from its median and mode, as shown in data block 480. The computations of moments and their dispersions can be extended to autocorrelations of time series and their correlations with reference series such as S&P or other indexes over time horizons that overlap with D. When D covers multiple horizons across TW, the computation of the relevant statistics across these time scales is presented Equations (8.1) through (8.6) above, for the case of mean and standard deviation. The extension of the method described herein to other statistical moments and further measures such as mode, median, autocorrelation, and other measures, is similar.

In the current embodiment of the invention, the dispersion metric requires a dispersion test to hold within a minimum number of data points. The test also tracks dynamically the length the data stream over which the dispersion check will hold within dispersion thresholds. Since the present embodiment includes the tracking of dispersions of the mean series in comparison with mode and median series, the method also delivers the functional reconstruction of the probability distribution of data series irrespective of the stationarity of the data set. This is a key feature of the current embodiment of the invention, since obviously any data series from financial markets is non stationary, and can only be approximated as a stationary series within acceptable error margins.

6. Numerical Functional Reconstruction Example: The Correlation Function

To provide further details of the current embodiment of the numerical construction of probability distributions, the logic of the implementation of correlation series is described below. This current embodiment uses the Pearson correlation method, and uses linear interpolation to generate in-between data values across pairs of data sets whose correlation series are computed. The method can be interchangeably used with other correlation methods, and nonlinear interpolation techniques, such as multi-knot b-splines, for example, that can be effectively implemented as pipeline computations.

In the current embodiment of the invention, correlations between data sets are evaluated cyclically and values are synchronized via linear interpolation and extrapolation. Although data from feeds from multiple markets are captured continuously, correlation series are computed over segments of data cyclically. Hence, correlation following synchronization through linear interpolation that is described above is not carried out one data point at a time, but cyclically over segments of data feeds. These time cycles are denoted as Tₘᵢₙ.

These minimum lengths of these cycles are set as a baseline metric for evaluating correlations. Tₘᵢₙ time cycles are fine-tuned according to the computational power of the underlying hardware. The minimum length of a time cycle is fixed for a data broadcast session. The number of integer multiples of the minimum time cycle that is used for evaluating correlation series, denoted as U, is fixed.

Data streams are matched with the cycles to compute correlations. When and if data is observed within the first U time horizon for the data feed of an equity upon connecting to markets, then the system turns on a flag Fₘᵢₙ^{j} to broadcast to other data feeds that this particular market signal is ready for evaluating its correlations with other data feeds. The invention computes the integer multiple of the minimum time cycles Tₘᵢₙ that this data series covers. Since the last captured data point falls somewhere between the end of the last data cycle and the end of the data cycle before the last one, the remaining time window between the last data point and the end of the last minimum cycle is a time region where there was no activity in this market.

Hence, for example, if the correlation module is tracking price series (market ticks), then this region of no activity would imply that no transactions have occurred in this time interval. Consequently, the last data point before the end of the last minimum computation cycle is directly extrapolated to the end of the last computation cycle as the last point of the data series for the computation of the correlation.

When a data series broadcasts its availability to compute its correlations with other series, then the system checks the list of other available data feeds to initiate the evaluation of correlations. Correlations of any two data series are computed over the same integer numbers of the minimum time window Tₘᵢₙ. The number of data points in each data feed may be different. Data series for equities are linearly interpolated as described above to synchronize the computation of correlations on the same time tags for both series. Data points within the last minimum time window are aligned as described above.

Correlation series are generated cyclically over a moving time window whose length U is an integer multiple of Tₘᵢₙ. U is a parameter that is equal for all correlation computations across all pairs during a trading session. The correlation series are computed at U points each time the moving time window U×Tₘᵢₙ advances by Tₘᵢₙ. Correlation series are tracked by a minimum of Lₘᵢₙ cycles of Tₘᵢₙ by the correlation module before they are published as potentially correlated.

Correlation series are subjected to the following tests before they are validated for further processing by the trading system. The correlation of the two input streams is computed over U−1 past and the current Tₘᵢₙ cycle is computed at each advance of the moving time window U to the next Tₘᵢₙ. Magnitudes of correlations are checked to see if they fall below a preset threshold value c_{threshold} at each advance of the moving time window U to the next Tₘᵢₙ.

If the correlation series pass the correlation threshold test, then they are subjected to the dispersion test with z-score at each advance of the moving time window. The z-scores of the series over U−1 past and the current Tₘᵢₙ cycle is computed at each advance of the moving time window U to the next Tₘᵢₙ. The z-scores are checked to see if the fall within the z_{threshold} following each computation.

If entries of a correlation series pass both the correlation threshold test and the dispersion test consecutively beyond a preset f_{threshold} number of times, then the pair that makes up the correlation series is published as a potentially tradable.

If the ratio of successes to failures of successive correlation tests for a correlation series over a time horizon Lᵣ is above some threshold r_{threshold}, then the correlation series is considered admissible.

The preceding tests identify pairs of streams of market data feeds for correlation. The correlation matrix is updated at each following each Tₘᵢₙ with the outcomes of correlation tests that are conducted over the last U time windows for each pair. These pairs form connected graphs whereby all possible transitive relationships between any selected pairs are lumped into a graph. Consequently, no vertex of the graph (a market data feed that has pairwise correlations that have passed the correlation tests with one or more equities) appears in more than one graph. Any of these graphs that include potential pairs will be identified by further processing of each graph via a simple variation of known weighted graph algorithms for rank ordering correlations.

The parameters of the correlation test that are described above are listed in Table 1 and Table 2 below.

TABLE 1
Input Parameters of the Correlation Module

| | |
|---|---|
| R | R is the symbol list; the data streams for the equities in the symbol list are to be checked for their |
| | correlations. The set of equities can be written as {Aⱼ\|j ε [1, R]; (j, R) ε I × I}; |
| | R is a vector or an array |
| Iₘᵢₙ | Iₘᵢₙ is the size of the interpolation window across which normalized data streams are interpolated at |
| | equidistant time intervals sₘᵢₙ. Iₘᵢₙ is an integer multiple of sₘᵢₙ |
| | Iₘᵢₙ is a real number. |
| sₘᵢₙ | Equidistant time steps the output values of the linear interpolation function; data streams from |
| | markets are processed by the filter function and normalization function before being fed into the |
| | linear interpolation function. sₘᵢₙ is a real number. |
| Tₘᵢₙ | The length of the standard time window for the computation of correlation series between |
| | normalized data streams from {Aⱼ\|j ε [1, R]; (j, R) ε I × I); Tₘᵢₙ is set for a trading session; all |
| | correlations across all data streams are computed at time points that are integer multiples of Tₘᵢₙ. |
| | Tₘᵢₙ is a real number. |
| U | The width of the moving time window in terms of integer multiples of Tₘᵢₙ and over which |
| | correlation series are sequentially updated at each Tₘᵢₙ; hence, for each data stream that is being |
| | tracked, correlations at each advance of Tₘᵢₙ are computed by using the last U periods of Tₘᵢₙ. U is |
| | fixed across all pairs for a trading session. |
| | U is an integer. |
| c_{threshold} | The absolute value of the threshold for the correlation threshold test |
| | C_{threshold} is a real number. |
| z_{threshold} | The maximum value of the z-score for the z-score test |
| | Z_{threshold} is a real number. |
| L_{f} | The minimum number consecutive evaluations of the entries of correlation series are expected to |
| | pass before the pair that make up the correlation series is published as potential tradable |
| | f_{threshold} is an integer. |
| r_{threshold} | The parameter for the success rate of correlations over a time window; r_{threshold} is a preset |
| | threshold value for the ratio of the number of Tₘᵢₙ where correlation computations passed all of the |
| | previous threshold tests, to the number of Tₘᵢₙ where correlations failed the threshold tests. |
| | r_{threshold} is a real number. |
| Lᵣ | The minimum time window for evaluating sequences of r_{threshold}. Lᵣ is a multiple of Tₘᵢₙ. |
| | Lₘᵢₙ is an integer. |

TABLE 2
Internal Parameters of the Correlation Module

| | |
|---|---|
| Fₘᵢₙ^{j} | The flag that indicates that data was captured from data stream for equity symbol Aⱼ during an |
| | integer multiple of Tₘᵢₙ. |
| μ(i, j)\|_{T}ₘᵢₙ^{m} | The value of the mean of the correlation between data streams from equity Aⱼ and Aₖ at m'th cycle |
| | of Tₘᵢₙ; the mean is computed over U data points; m ≧ U. |
| | μ(i, j)\|_{T}ₘᵢₙ^{m} is a real number. |
| σ(i, j)\|_{T}ₘᵢₙ^{m} | The value of the standard deviation between data streams from equity Aⱼ and Aₖ at m'th cycle of |
| | Tₘᵢₙ; the standard deviation is computed over W data points; m ≧ W. |
| | σ(i, j)\|_{T}ₘᵢₙ^{m} is a real number. |
| c(i, j)\|_{T}ₘᵢₙ^{m} | The value of the correlation between data streams from equity Aⱼ and Aₖ at m'th cycle of Tₘᵢₙ, the |
| | correlation is computed over U data points; m ≧ U. |
| | c(i, j)\|_{T}ₘᵢₙ^{m} is a real number. |
| z(i, j)\|_{T}ₘᵢₙ^{m} | The value of the z-score between data streams from equity Aⱼ and Aₖ at m'th cycle of Tₘᵢₙ, the z- |
| | score is computed over U data points; m ≧ U. |
| | z(i, j)\|_{T}ₘᵢₙ^{m} is a real number. |

The execution logic for testing of the correlation series is presented below. These tests are based on pairwise market signals passing the correlation test according to both the persistence of these correlation series over minimum and preset time windows checked against correlation thresholds, and the dispersions of mean and standard deviation series of these correlation series passing the dispersion tests over minimum dispersion test time windows.
Initiate the correlation series evaluation function in the analytical utilities module:

Set the input parameters of the trading session:
{R, Tₘᵢₙ, Iₘᵢₙ, sₘᵢₙ, U, L_{f}, Lᵣ, c_{threshold}, z_{threshold}, f_{threshold}, r_{threshold}};
Connect to markets for the equity symbol list R:
{A₁, . . . , Aⱼ, Aₖ, . . . , A_{R}};

For all Aⱼ, j ∈ [1, R], start capturing data streams:
Start applying the filter function, the data normalization function, the linear interpolation function separately to all data streams; the interpolated data series are equidistant by sₘᵢₙ; generate the interpolated data series for
   When the time tags of input data streams equal or exceed an integer multiple of Tₘᵢₙ; set Fₘᵢₙ^{j} ON;
   Check for all other Aₖ whose flag Fₘᵢₙ^{k} is ON;

For all pairs (Aⱼ, Aₖ) whose flags Fₘᵢₙ^{j} and Fₘᵢₙ^{k} are ON, do the following:
Computation of correlations between pairs via iterations of moving windows:
   Generate the first value of the correlation series between Aⱼ, and Aₖ by applying Pearson's correlation formula at the point: m×Tₘᵢₙ.
   Advance the window U by Tₘᵢₙ.
   Update the data feeds from Aⱼ and Aₖ for the time advance of Tₘᵢₙ. Synchronize them via linear interpolation and extrapolation over this new. The linear interpolation is carried out consecutively over shifting U's. Only the data points in the last Iₘᵢₙ of U are interpolated.
   The previously interpolated series from the former position of U is concatenated from left to new interpolated series across Iₘᵢₙ, while dropping the leftmost data points over an interval Iₘᵢₙ in the previous position of U.
   Compute the correlation coefficient at the end point of U.
Execute correlation tests on correlation series:

At each Tₘᵢₙ advance of U, apply the correlation tests to correlation series:
Correlation threshold test applied to each the last U elements of the correlation series
Dispersion test (z-threshold test) applied to the last W element of the correlation series
Consecutive correlation test over the last L_{f} cycles of Tₘᵢₙ
Success-to-failure ratio test over the last Lᵣ cycles of Tₘᵢₙ
Identify pairs whose correlations pass the tests above.

Publish and refresh these pairs in correlation matrix at each advance of Tₘᵢₙ.
Identify potential pairs:
   At each advance of Tₘᵢₙ use the weighted graph algorithm to generate:
   potential pairs;
   the correlation values among the elements of pairs;
the percentages of contracts of each market signal to be included in each pair.

The current embodiment of the invention uses the following weighted graph algorithm for rank ordering pairs following the execution of the correlation test above. The present implementation of the weighted graph algorithm can rank order both simple pairs of baskets with more than two signals. Each signal is counted at most in one pair or basket only. Otherwise, in a trading setting, the use of this algorithm will cause, for example, a symbol to be bought and sold while trading different spreads concurrently, thereby causing self-cannibalization of a spread trading strategy.

TABLE 3
Parameters for the weighted graph algorithm for rank ordering
pairs and baskets

| | |
|---|---|
| Pairs_{flag} | If the flag is ON, then the output module generated pairs |
| | only; if OFF it generates baskets (that may also include pairs). |
| | Pairs_{flag} is Boolean. |
| Basketsize | Maximum number of symbols to be included in a basket |
| | Basketsize is an integer. |

The logic of the weighted graph algorithm in the current embodiment of the invention is shown below.

Generate the list of pairs at the output of the correlation computation block:

Pairs _{flag}=1;

At the end of each Tₘᵢₙ:

generate the list of all pairs that pass the correlation tests;

order these pairs in descending order terms of the magnitudes of their correlations;

select pairs in descending order from this ordered list;

copy the selected pair and the value of their correlation to the output list;

for all selected pairs, remove from the orders list all other pairs that contain the same symbols as the selected pair;

continue until the list of ordered pairs is exhausted.

Generate the list of baskets at the output of the correlation computation:

Pairs_{flag}=0;

At the end of each Tₘᵢₙ:
generate the list of all pairs that pass the correlation tests;
order these pairs in descending order in terms of the magnitudes of their correlations;

{generate baskets by scanning the list of ordered pairs in descending order as follows}:
for each symbol Aⱼ and Aₖin the pair (Aⱼ, Aₖ) in the ordered list:
   scan the remainder of the list of ordered pairs to identify:
      up to or equal to Basketsize—2 symbols that are paired with Aⱼ, and
      up to or equal to Basketsize—2 symbols that are paired with Aₖ;
   add the magnitudes of correlations of pairs up to or equal to Basketsize—2 pairs where Aⱼ is one of the symbols; denote this sum as A_{j-weight};
   add the magnitudes of correlations of pairs up to or equal to Basketsize—2 pairs where Aₖ is one of the symbols; denote this sum as A_{k-weight};
   if A_{j-weight}≧A_{k-weight} then identify Aⱼ as the benchmark symbol for the basket;
      copy Aⱼ, Aₖ and Basketsize—2 symbols that are paired with Aⱼ to the output list;
         {the output:
         identifies Aⱼ as the benchmark, and Aₖ and Basketsize—2 other symbols as the other elements of the basket;
         includes the correlations among all elements of the basket}
      remove all pairs that include the Basketsize—2 symbols that are paired with Aⱼ from the list of ordered pairs;
   otherwise identify Aₖ as the benchmark symbol for the basket;
      copy Aⱼ, Aₖ and Basketsize—2 symbols that are paired with Aₖto the output list;
         {the output:
         identifies Aₖ as the benchmark, and Aⱼ and Basketsize—2 other symbols as the other elements of the basket;
         includes the correlations among all elements of the basket}
      remove all pairs that include the Basketsize—2 symbols that are paired with Aₖ from the list of ordered pairs;
continue until the list of ordered pairs is exhausted.

The test described above can be extended to further statistical measures, to include, mean, mode, skewness and kurtosis, and dispersion tests over these metrics, to characterize the probability distributions of correlation series of dynamic time windows as computed by using the correlation and dispersion thresholds.

7. Market Microstructure Data Generator (MG)

MG augments market data with its own market microstructure data feeds that are synchronized with underlying market data. Data feeds such as ticks and quotes, full order book depth, top of bid and ask side of order books, mid-point of bid and asks, market volatilities, and other market data features that are currently provided by market data providers will be complemented by MG's data. MG provides most market metrics that traders use and many algorithms that they build as a data feed. MG broadcasts the full order book at each update, therefore eliminating the need to synchronize periodically the order book that is built internally by trading systems with those of exchanges. MG's feeds are delivered as data streams that are normalized and time-stamped at each update of the market data feed by quotes, ticks, order cancellations, and different time intervals of multiples of microseconds, milliseconds, seconds, minutes and hours. In the invention's current embodiment, MG's output includes and is not limited to the following feeds which are all generated concurrently and in real time over multiple time windows. MG's feeds that are listed below will be familiar to those skilled in the art.

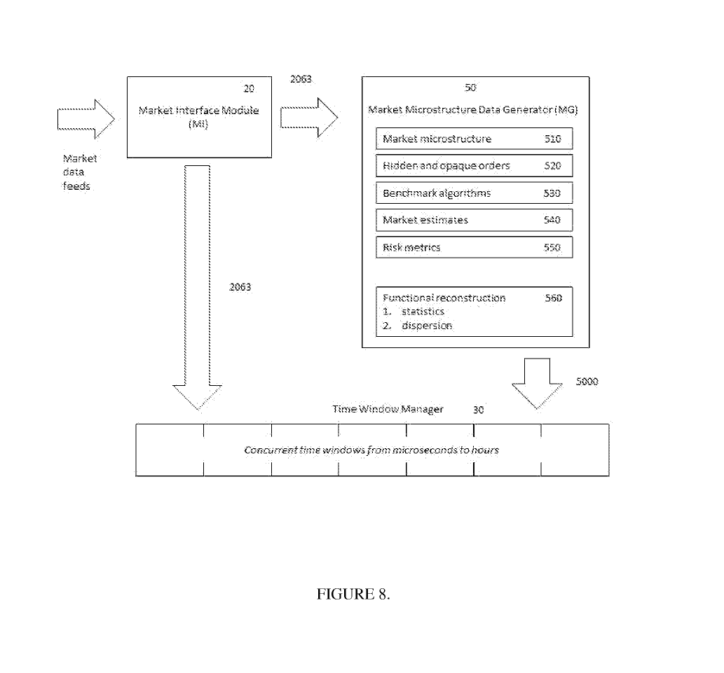

Referring now to FIG. 8, Market Interface Module (MI) 20 of FIG. 1 processes input data and generates data blocks of standardized feeds 2063 that were described above for the embodiment of MI in FIG. 3. MG 50 of FIG. 1 computes the feeds that are listed below from data block 2063. MG uses the libraries that are provided by the Analytical Utilities Module (AU) 40 of FIG. 1 while computing its output. AU is not shown in FIG. 8 to keep the depiction of MG's functions simple.

Instantaneous market microstructure feeds as shown in function block 510, including:
1. Order execution to order placement and cancellation ratios;
2. Ratio of bid/ask volumes of the limit order book;
3. Volumes of order sizes across the layers of the limit order book;
4. Volatility; moving average, entropy;
5. Sizes:

5.1. of new orders,

5.2. numbers of order cancellations; order updates;
at each level of the limit order book;
6. Order placement to order cancellation and order update ratios:

6.1. for each level of the limit order book;

6.2. between the tops of bid and ask sides of the limit order book;
7. Mid-point of bid and ask spread;
8. Spreads between the price feeds and key reference data feeds, including:

8.1. NBBO

8.2. major indexes;
9. Correlations between prices, mid points of bid and asks major indexes;
10. Short, mid and long term volatilities of prices, orders and volumes;
11. Statistics for order volumes across the depths of the bid and ask sides of the order book.

Feeds for the estimates of hidden and opaque order flows, as shown in function block 520, including, estimates for sizes and numbers of:
1. Market orders and their matched prices;
2. Fill-or-kill (FOK) and immediate-or-cancel (IOC) orders and their matched prices;
3. Hidden order placements, cancellations and replacements;
4. Conditional order types that are specific to exchanges whose data feeds are processed by MG.

Feeds for key benchmark algorithms for market dynamics, as shown in function block 530, including:
1. Volume weighted average price (VWAP);
2. Time weighted average price (TWAP);
3. Percentage of volume (POC);
4. Adaptive arrival price,

Feeds for market estimates as shown in function block 540, including:
1. Directional estimates based on quote flow imbalances;
2. Autocorrelations and entropies of quote and tick series;
3. Imbalances of market orders

Feeds for risk metrics as shown in function block 550, including:
1. implementation shortfall risk;
2. timing risk;
3. market impact risk;
4. drawdown risk,

that are parameterized to:
1. volume, liquidity, volatility;
2. order book depth;
3. market opaqueness profiles;
4. to bid or ask orders at:

4.1. top of the books;

4.2. depth of books;

4.3. for order sized normalized to:

4.4. order book liquidity.

MG's feeds are generated concurrently for all of the above market microstructure analytics feeds across different time windows from microseconds to hours. Each time window includes an adjustable number of data points for each MG feed.

The feeds above are delivered over multiple time horizons with functional reconstruction measures, as shown in function block 560, including their:
1. Statistics: mean, median, mean-median dispersion, variance, skewness, kurtosis, autocorrelation;
2. Dispersion metrics for statistics and entropy.

Data blocks 2063 and 5000 are synchronized over multiple horizons of the Time Window Manager (TW) 30 of FIG. 1.

As an example of data flow synchronization, the simple case of quote and tick feeds will be described next. In the current implementation of the invention, quote data streams at any level of the order book are averaged for price and volume information at the arrival of each new quote at that level. Averages of quote data at all levels of all limit order books are stored as the average market data values for their respective levels of their respective limit order books. New averages for quote data are computed and stored between arrivals of new trade data for any equity in the basket, for all levels of limit order books and for all equities in the basket. If no quote data has arrived in this interval for a given level of a limit order book, the average quote data is extrapolated from the previous market data average. The numbers of arrivals of these quotes between the arrivals of new trade data for any equity, for each level of each limit order book, are stored. If no new trade data has arrived for any equity between two synchronizations of market data, then the trade data for this equity is extrapolated from its previous value. The numbers of extrapolations between the arrivals of new trade data for any equity are stored. The total numbers extrapolations for each trading session of the trade execution module are stored.

Methods for estimating hidden orders and effective spreads will be presented next as examples of implementing these MG's data output block 5000 in the current embodiment of the invention. With a quote based feed, it is possible to estimate the volume of hidden orders. This involves using both trade tick data as well as the quote based feed. The hidden order volume is estimated as the difference between the total ticks (settled trades) within a time window minus the number of ticks that were between the immediately previous bid-ask spread. This can only be estimated when the bid-ask spread being used is over a single penny in value.

Counting the total ticks over the window is simply the window size of the tick data. The bid-ask spread needs to be kept current from the quote based data feed and the current value used to determine if the tick should be counted for the difference. Since this calculation uses both a tick feed and a quote based feed, the equations need to reflect the sequence of the events in order. The calculation is generated as a tick based computation, using values derived from the quote based feed.

Inputs: Both a trade and quote based (quote, depth, BBO, etc.) data feed.

Outputs: Hidden order estimate.

Implementation: The calculation is performed as part of processing the tick data feed, using data from the quote feed as input. An accumulating value of the hidden tick count over the window is maintained for the calculation. For calculating the estimate at tick index i, the most recent quote event index is defined to be j. The bid and ask values used can be either the actual bid and ask, or the effective bid and ask as described below in the evaluation of effective spread. As each tick is received, a determination is made about whether the tick is hidden or not. The tick results are either 1, indicating the tick is hidden, or 0, indicating that the tick is not hidden. The results are determined as defined in equation (1) below. The cumulative number of hidden ticks within the window is given by equation (2), and the calculation for the hidden order estimate is given in equation (3).

$$\begin{matrix}W = window size of the tick feed & \\ i = current tick data index & \\ j = most recent quote data index & \\ {h}_{i} = \{ \begin{matrix}1 ; & \begin{matrix}{bid}_{j} < {x}_{i} < {ask}_{j} \\ ( {ask}_{j} - {bid}_{j} ) > 0.01\end{matrix} \\ 0 ; & otherwise\end{matrix} \} & ( 1 ) \\ {h}_{i} = {h}_{i - 1} + {h}_{i} - \{ \begin{matrix}\begin{matrix}{h}_{i - W} ; & i \geq W\end{matrix} \\ \begin{matrix}0 ; & i < W\end{matrix}\end{matrix} \} & ( 2 ) \\ {H}_{i} = W - {h}_{i} & ( 3 )\end{matrix}$$

Effective spread is an adjustment to the bid-ask spread to be used in calculations that use this spread value. It adjusts the spread to account for the volatility of recent settlement prices. This adjustment is done by adding to the ask price or subtracting from the bid price. If the side information is not available from the tick (trade) data feed, then these calculations cannot be performed and the result does not change the bid or ask values.

Inputs: Trade (tick) data feed, and quote based (quote, depth, BBO, etc.) input data feed.

Outputs: Adjusted bid or ask value at the current quote based event time, or null.

Implementation: The effective spread calculations are performed by determining the side of the last trade and adjusting the bid or ask price accordingly.

$$\begin{matrix}i = most recent trade event index ; j = current quote event index & \\ {ask}_{effective , i} = {ask}_{j} + \{ \begin{matrix}- {σ}_{i} ; & {x}_{i} < {ask}_{j} \\ {σ}_{i} ; & {x}_{i} > {ask}_{j}\end{matrix} \} ; side = SELL & ( 1 ) \\ {bid}_{effective , i} = {bid}_{j} + \{ \begin{matrix}- {σ}_{i} ; & {x}_{i} < {bid}_{j} \\ {σ}_{i} ; & {x}_{i} > {bid}_{j}\end{matrix} \} ; side = BUY & ( 2 )\end{matrix}$$

8. Market Microstructure Data Ticker Plant (TP)

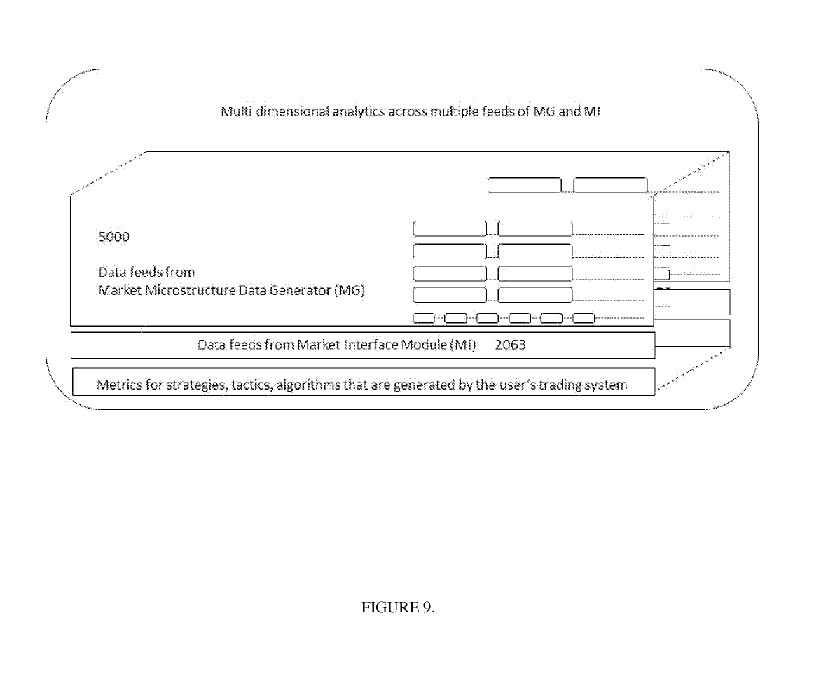

Referring now to FIG. 9, the Ticker Plant consolidates the feeds from multiple markets as shown in data block 5000 that are generated by Market Microstructure Data Generator (MG) of FIG. 1 with their underlying data feeds as shown in data block 2063 that are generated by Market Interface Module (MI) 20 of FIG. 1. TP is designed as a multidimensional, on-line analytical processing (OLAP) engine that is scalable and reconfigurable across multiple and diverse markets. TP can be collocated at single or multiple sites and its functions can be executed as either a standalone or distributed systems.

9. Market Simulator (MS)

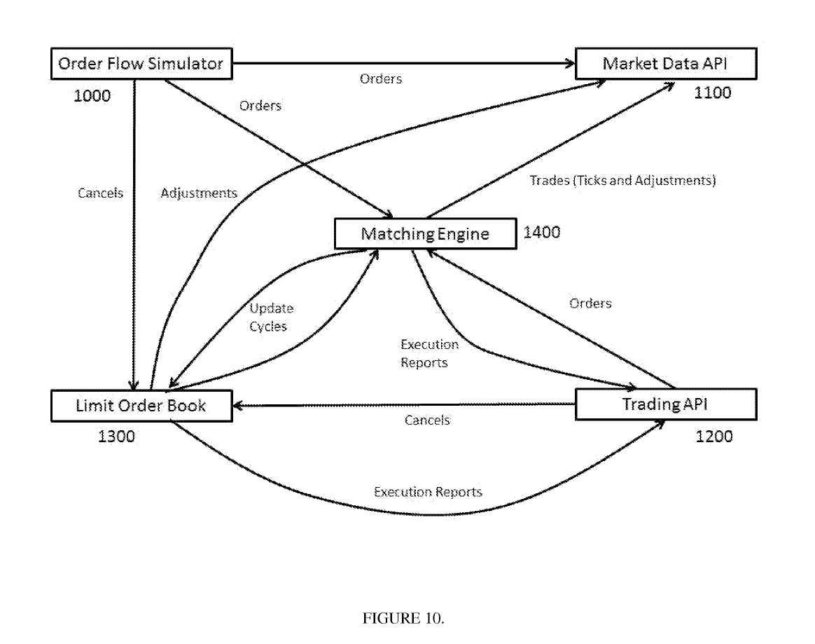

MS enables the simulation of electronic markets with high levels of detail, to mimic the market dynamics of actual exchanges, and to test the performance of trading algorithms' performance and effects of order matching rules efficiently. MS generates order streams similar to what are expected from a real exchange. The architectural elements that are shown in FIG. 10 for the current embodiment of the invention include:

| | |
|---|---|
| 1. Order Flow Simulator, functional | Creates order flow used to |
| block 1000 | match orders with. |
| 2. Market Data API, functional | Interface to external market |
| block 1100 | data consumers |
| 3. Trading API, functional | Interface to external order sources. |
| block 1200 | Order execution reports |
| | are returned via this API. |
| 4. Limit order book, functional | Tracks the outstanding limit |
| block 1300 | orders from the order flow. |
| 5. Matching Engine, functional | Matches orders from the order |
| block 1400 | flow and from external |
| | sources to existing orders |
| | and removes matched orders |
| | from the book, creating ticks |
| | and order fill messages as |
| | appropriate. |

MS enables the testing of trading strategies under various market conditions and with different features of matching engines. These simulations can run at high speed and provide insights about estimated performances of trading strategies within hours, instead of months of paper trading. MS can be connected to an actual matching engine and can be used to generate various mock markets by using MS's simulated market data generation utilities, including market agents. Hence, MS provides exchanges and trading platform operators with the ability to test new order types and qualifiers given expected liquidity, volatility and volume patterns in markets. MS can merge historic market data with its own simulated market data, as well as modulating historic market data to test evolving market conditions.

MS can also be connected to actual order flows via the Market Data API as shown in functional block 1100, and can be used to check various matching engine features, such as order sequencing, order processing precedence, performance requirements to process complex orders such as pegged orders, and various order qualifiers. Hence, MS provides exchanges and trading platform operators with the ability to maximize the performance of their matching engines for new markets.

Both actual order flows and matching engines can be connected to the market simulator for perturbation analyses, under different order flow conditions, order matching rules, circuit breaker rules. This feature is especially useful for testing market stability under different stress conditions, and estimating systemic risks to markets.

The Matching Engine as shown in functional block 1400 receives the full order flow from the order flow simulator. It also receives new orders from the Trading API as shown in functional block 1200. It has direct access to the Limit Order Book (LOB) as shown in functional block 1300 that allows it to add and remove orders from the LOB as well as query for sets of orders contained by it. If a new order is received, it is checked for a match in the existing LOB. If no match is found, the new order is entered into the LOB. If a match is found, the matching order is removed from the LOB, an adjustment order is generated and a tick is generated. The adjustment order and tick are sent to the market data interface for propagation to any interested receivers. If an order received from the Trading API is matched, an order execution report is propagated back to the Trading API. The internal matching engine for the exchange simulation will match orders using price and side to determine applicability, and attempt to find the nearest size order to match with. If more than one order has the required size, then the order of matching is unfilled. If no exact match for size is made a heuristic will be followed to select the order or orders to match. The Matching Engine includes a library of matching filters that track the order book to determine a candidate set of orders to match with incoming orders.

Order Flow Simulator

The order flow simulator is based on creating a flow of orders that can drive price values in a desired direction. That is, when configured to have price movement, the order flow should create orders that cause the price to move as desired. Independent order flows can be created for each security needed. The order flows for securities are independent and have no interactions other than using the same interfaces for the trading clients and the market data feeds. Aspects of the order flow include: generation of orders by type, total liquidity, and price movement.

The specific flow rates for each order type, the order prices, and the order sizes are all selected using probability density functions to select values with. The overall characteristics of the distribution will determine the specific values that are used to generate orders over time. Controls to the order flow are the total liquidity, which specifies the desired value of the total volume of orders in the limit order book, and order book balance, which specifies the balance of volume between the bid side and the ask side of the order book. The total liquidity control sets the number of outstanding orders and the balance control is used to move the price. Measurements of the current state of the order book are used to derive rates of the order types as well. These include the aggregate bid side volume, the aggregate ask side volume, the best bid price, and the best offer price. The volume information is used in setting the rates for the different order types to be generated and the prices are used in setting the price of new orders.

Order Generation

The order flow creates new orders of different types at an average rate determined by a control input. Each of the order types that can be issued are assumed to be independent and conceptually they can be generated using completely separate mechanisms then combined into a single stream to be applied to the matching engine. Since the matching engine must process orders one at a time, any combined order flow with simultaneous orders will need to resolve these simultaneous orders into the sequence in which they are processed. This same stream can be generated using a single stream of orders and selecting the order type for each order at the time it is created. Allowing intervals between orders of zero duration will account for simultaneous orders. Generating a single order stream and determining the order type as orders are created simplifies the implementation; and is equivalent to the combination of several independent streams. The different stream rates would then be combined into a single stream rate, with probabilities of an order type used to create the equivalent stream.

Market Agents

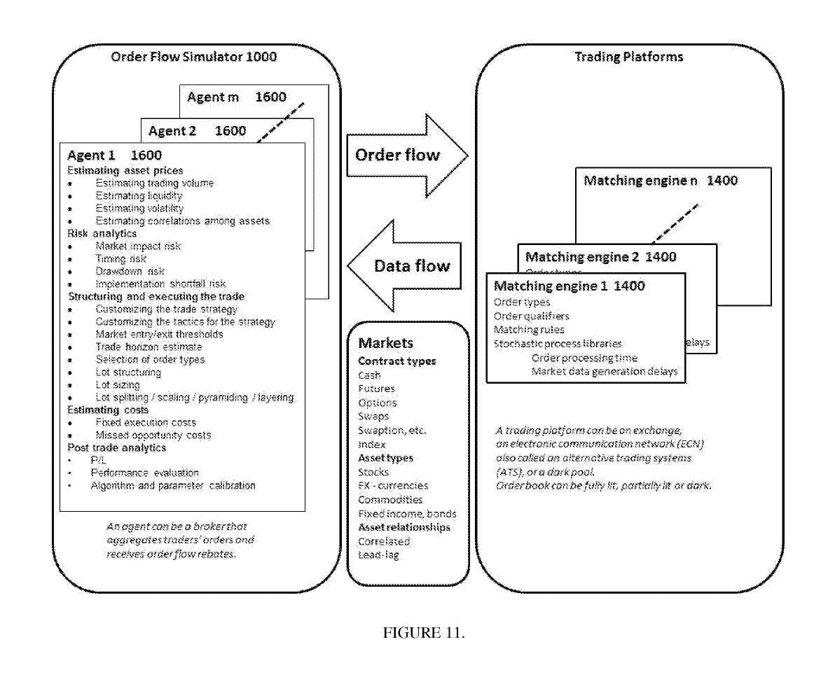

Market agents use the well-known Rete algorithm as an inductive reasoning function to operate agents in different modes of market participation, including market maker, market taker, slow to high frequency taker, with parameterized risk tolerances, market entry and exit thresholds. Rete's pattern matching features are applied to market signals, order placement patterns, profit/loss patterns, order cancellation patterns across dynamic time windows for each of these time series and matched with respective libraries of algorithms for market estimation, risk assessment and for computations for position entries and exits. The design and operation of market agents are described in FIG. 11. Market agents whose functions are shown in the functional block 1600 are components of the Order Flow Simulator as shown in the functional block 1000 from FIG. 10. An agent may track and trade with multiple markets whose matching engines as shown in the functional block 1400.

Order Flow Generation

Values used by agents in the creation of the order flow for the order flow simulation by agents are taken from non-stationary stochastic processes. These processes are generated from a library of probability distribution functions that are part of the Analytical Utilities Module (AU). The current embodiment of the invention includes fixed, uniform, exponential, Gaussian, Rayleigh, and Wiebull distributions. The fixed distribution allows the use of constant values with the same interfaces (distribution function and parameters) as the other distributions. This allows any of the random variables in the processing flow to be substituted with a constant which is useful during development and testing. The Uniform distribution is the standard random number generation where a value with equal probability is taken from a range of values. This is useful in selecting order types as well as determining the status of other randomly selected criteria, such as, for example, odd lots or whether an order is in the market or away from it. The linear distribution is used to generate a uniformly varying probability from the low to high end of the range. The exponential distribution is used to generate intervals between orders which results in the orders exhibiting Poisson arrival times. The Gaussian distribution is use where standard normally distributed random values are needed. There are currently no uses of this distribution, but as more complex usages are composed, this may be an integral part of these compositions. The Rayleigh distribution is a distribution limited on the low end with a single shape parameter determining both its mode and deviation. It can be used to generate prices and sizes of orders. The Weibull distribution is a general purpose probability density function that is identical to the exponential distribution when its shape parameter is 1 and identical to the Rayleigh distribution when its shape parameter is 2. While this can be used to derive deviates from those distributions, those are retained separately to allow faster implementations of deviate value generation.

In its current embodiment, MS includes limit orders, market orders, and cancel or cancel/replace orders. Each order type has a rate that is related to other orders types. The details of generating order types include the ratios of the different types and the responses to control inputs and measurements. Controls to order type generation include total desired liquidity which affects the amount of volume in the order book, and the desired balance which affects price movements. In addition to the type of order, limit orders of any type can have associated flags that modify the behavior of order matching and reporting. These flags are all part of the hidden order processing feature, since they are (mostly) used together to provide and match hidden order volume.

Limit orders are orders that are not immediately matched with an existing order are retained in the limit order book. These orders can be on the bid side or the ask side of the book. The rate of new bid-limit orders and new ask-limit orders will be the same for a balance book. If an imbalance is desired, these rates will be adjusted. This is how price movements are created and is discussed below. Limit orders are the only way new orders can be added to the limit order book. Since total liquidity on both sides of the limit order book is a control input, the rate at which these orders are created will be adjusted to reach the desired liquidity. Once the desired liquidity has been reached, the rate of new limit orders will be matched by the aggregate rate of marketable limit orders, market orders, and order cancellations. This is necessary to retain a consistent liquidity level within the book.

Marketable limit orders are orders which are placed in the opposite side of the limit order book and are immediately matched. They are not entered in the order book since they will match an existing order and not need to be retained for a possible future match. It is possible that a marketable limit order is not fully filled by the existing orders on the opposite side of the book. In this case, the remaining (unfilled) portion of the order is retained as a new order in the limit order book. This new order fragment is caused by a limit order that has more volume than is available to match at or better than the limit price. Orders of this type will remove liquidity from the order book and so the creation rate of these orders will be less than the rate of limit order creation. The rate of bid and ask marketable limit orders will always be equal so that liquidity is consumed from each side of the book equally. An imbalance created by the limit order rates will be retained until those rates are adjusted to remove the imbalance. This simplifies order management and price movements by reducing the number of control inputs to a single imbalance input. Market orders are similar to marketable limit orders except that they always match fully unless the opposite side of the book is completely exhausted. Volume from the opposite side of the book will be matched until the entire market order is filled. The market order rate is specified as a fraction of the marketable limit order rate and will typically be between 1% and 5%. The rate of buys will always equal the rate of sells for these orders.

Cancellations remove existing orders from the limit order book. The exchange simulator selects from the existing orders using the same criteria that are used to create limit orders in order to identify which order to cancel. The distributions used can be independently set and the parameters unique to cancellations if an independent cancellation profile is needed. The cancellation rate is specified as a fraction of the marketable limit order rate and will typically be around 50%, but can vary without bound to match actual market conditions. The rates of bid cancellations will always equal the rates of ask cancellations. Cancel/replace orders move existing orders in the limit order book. They may change the limit price, the size, or both the limit price and size of an existing order. Selection of the order to cancel and replace is done identically to selection of cancellations, with independent distribution and parameter selections. The replacement order is generated as if it were a new order within the book using the same mechanisms as creating new limit orders but with independently specified distribution and parameter settings. The cancel/replace order rate is specified as a multiple of the limit order rate is typically in the range of 10 to 15 times the number of new limit orders. This large multiple has the effect of driving the volume profile of the limit order book to match that of the distribution profile for these orders. The rates of bid cancel/replace orders will always equal the rates of ask cancel/replace orders.

Hidden orders are orders that are not reported as part of direct market access feeds and which are placed lowest in matching priority. They also do not affect the best bid or offer (top of book) prices. In addition to orders that are hidden, orders can be classified with a flag indicating fill type: Normal, IOC (Immediate or Cancel), or FOK (Fill or Kill). In addition to the fill type flag, a hidden flag indicates whether an order is hidden or visible. This is summarized in the following table:

| Flag | Value | Name | Description |
|---|---|---|---|
| hidden | — | Normal | Order is visible in order book, reported as market data, and affects the top of book |
| | | | pricing. |
| hidden | H | Hidden | Order is hidden. That means that the order is placed last in matching priority and is not |
| | | | reported via direct market access feeds. It also is not considered for determining the |
| | | | top of book prices, which allows the order book to have hidden orders located in the |
| | | | market. |
| fill | — | Normal | The order is either immediately matched or added to the order book. |
| type | | | |
| fill | IOC | Immediate or | Order will fill as much as possible with the current order book and any remainder will |
| type | | cancel | be cancelled rather than be placed into the order book |
| fill | FOK | Fill or Kill | Order will be entirely filled with the current order book or cancelled. It will not be |
| type | | | placed in the order book. |

Hidden volume can be added to the order book at any level. If an order is added that will match an existing order, it will fill and not be added, regardless of whether it is hidden or not. This prevents the absurd case of having hidden volume at prices that are in the opposite side of the book. Typically hidden volume is issued in the market (between the top of book for both sides). The motivating scenario is where an institution wants to make a very large order and is willing to “meet halfway” from the current top of book, so places hidden order volume at the current midpoint. It is also possible, though less common, to issue hidden volume in the book at either top of book or another layer price. This is done to reduce market impact risk for large orders. The order flow simulator will issue all normal limit orders at the midpoint as hidden orders to match the expected market behaviors. Additional hidden order volume will be generated at some low probability for all other limit orders. Hidden volume that is in the book—at prices that are visible in the order book—will be found as part of normal order generation and matching. It will result in additional volume being matched that was not directly visible. No special actions need to be taken in order to process volume. Hidden volume at the midpoint (current or previous) can be found by traders without affecting the current order book by issuing either IOC or FOK orders in the market. This allows matching of existing hidden volume without moving the top of book price to the midpoint if there was no hidden volume present. The order flow simulator will issue all marketable limit orders at the midpoint as IOC or FOK orders to match the expected market behaviors. Additional IOC and FOK orders are generated at some low probability for all other marketable limit orders.

The simulation of order types by the agents is done by selecting the relative flow rates of the different possible types of orders. The simulator generates order types from control and measurement criteria. This simulator accepts the current state of the order book, in the form of the current aggregate volume for each side of the order book, and the control inputs indicating the desired liquidity and desired bid/ask balance to be achieved. Additional configuration parameters complete the set of inputs that control the order type generation. A selection of orders using probabilities proportional to their individual flow rates at a rate that is the sum of all the flow rates is equivalent to generating multiple flows, one for each order type, at the respective rates.

The simulator model consists of an interface function which calls two internal functions to devise the actual type selection process. The interface function accepts the full set of control and measurement inputs, along with configuration parameters, and returns a set of order types as indicated by the arguments of the call. The function will generate any number of order types at a single time. These multiple order types are for a single set of control and measurement values. The controls and measurements will in general be varying in time and not stationary. The returned list of types will be a sample from the current ensemble and can be used as such.

The internal function that selects which order types to generate and creates the output list accepts a cumulative probability distribution and generates order types according to the individual probabilities. The cumulative distribution is used as a set of ranges from which a uniform random value is matched to determine the order type. The result is that if a uniformly random value is within a given range, an order of the type for that range is generated.

The internal function that generates the cumulative distribution that is used to select the order type uses the configuration parameters, control inputs, and current state of the order book in order to determine the relative flow rates for the different order types. A list of ranges is then formed for use by the order type selection function.

Generation of order prices is done in a piecewise fashion. Prices can fall into one of two regions: in the market (between the bid/ask spread); or, at and away from the market (in the order book). Each of these regions is characterized separately to allow for the in the market orders to be located and spread differently from the orders at and away from the market. The details of price generation include setting the parameters, obtaining normalized price values, then scaling the values to actual prices and discretizing to the minimum tradable amount.

Order prices will have different price generation characteristics. Limit orders will be placed at prices that are spread through the order book with a preference towards the top of book, and orders in the market will typically cluster around the midpoint price. At times these profiles will be modified with other characteristics to model different market behaviors. Market orders have no price generated for them, as they will always start at the top of book price of the opposite side and consume volume until exhausted, with the price adjusting as the volume of individual layers is exhausted. Marketable orders will be placed at or away from the market with a very strong tendency to be at the top of book price for the opposite side. It will be a rare event where a marketable order price reaches into the opposite side book layers. There is no in the market order prices for marketable orders (as they will not be marketable in this case). Cancellations and the cancel portion of a cancel/replace order have no prices generated. Cancel/replace order will select a new price value based on distributions similar to those for new limit orders. These orders can be thought of as new limit orders, but the ability to specify the price profile independently allows the cancel/replace behaviors to be modeled as different from new limit order behaviors. Each order may have an attribute of being hidden or visible. The order flow will be sent to the internal matching engine for further processing. Since orders may be matched as they are generated, only orders that do not match are forwarded on to the market data API for distribution to subscribers. Cancellations will be generated as special orders that reach the LOB and cause existing orders to be removed and an adjustment order forwarded to the market data API.

An order book at equilibrium—sideways price movement—will have approximately equal volume on each side of the book, and approximately equal rates for the different order types. Price movement can be induced by creating an imbalance in the order type (bid/ask) ratios, which will result in a volume imbalance in the LOB. The volume of marketable orders is much smaller than the volume of orders in, at, or away from the market. Observed ratios of ticks to orders in actual exchanges can range from 20 to 60 orders per tick. The mechanism to move the price is based on the creation of an order imbalance between the sides: a greater volume of orders on the bid side (demand) should drive prices up, and a greater volume of orders on the ask side (supply) should drive prices down. As the order book becomes unbalanced the price should be moving to attempt to reach a balanced state. This balance is dominated by the volume at the top of the book for each side. If the volume profile for a side has a peak that is away from the top of the book, the smaller volume at the top of the book will cause the prices to move until that peak is reached and either reverses the price movement, if the peak is larger than the other side volume, or slow or stop the price movement if the volume is under or comparable to the opposite side.

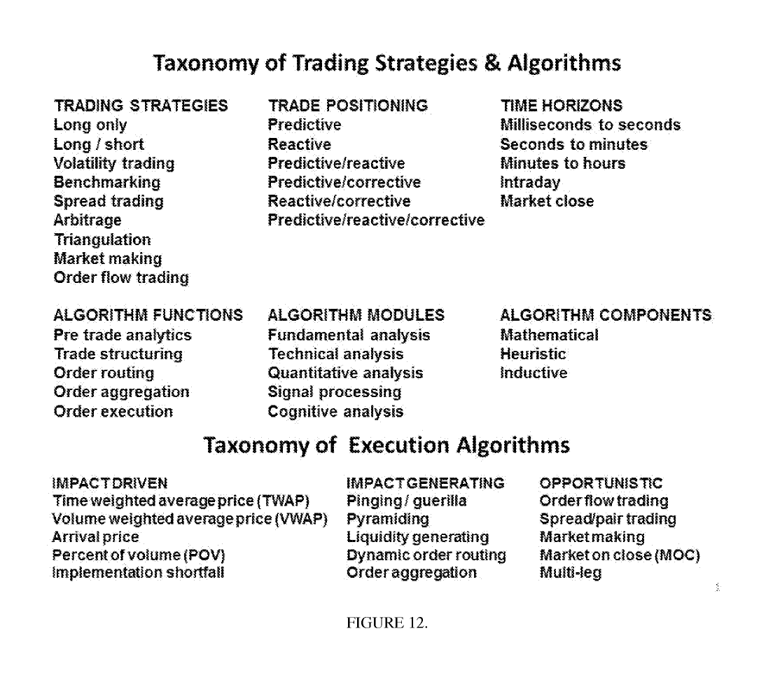

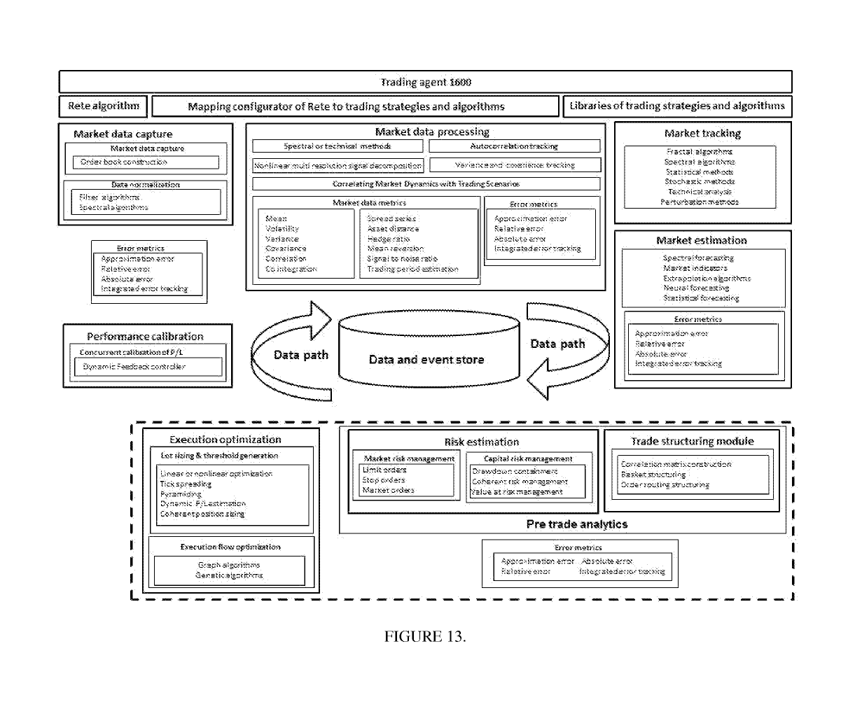

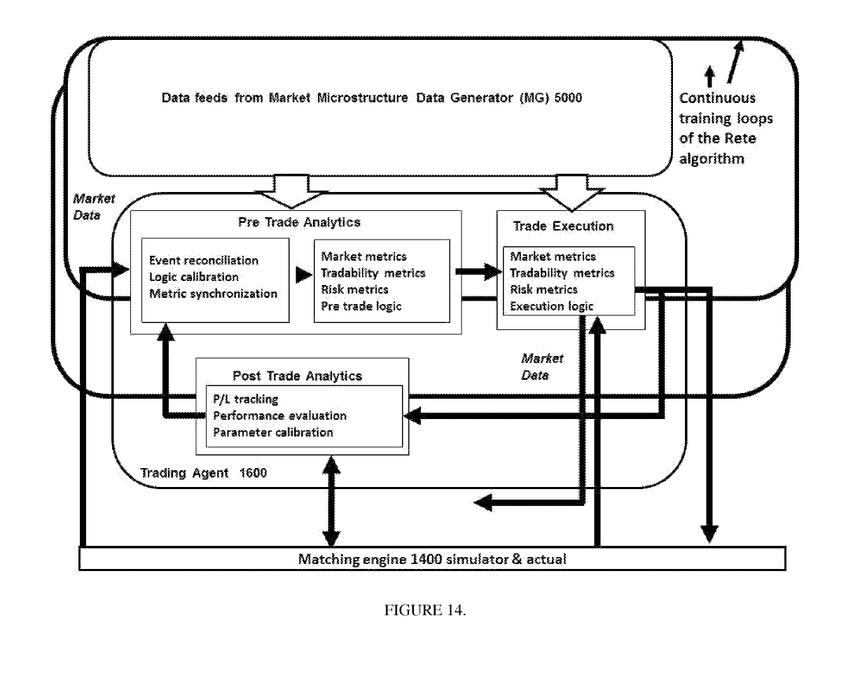

The taxonomy of trading strategies and the constituent algorithms of these trading strategies in the present embodiment of the invention is shown in FIG. 12. FIG. 13 depicts the implementation of a trading agent as shown in functional block 1600 in the present embodiment of the invention, as a feedback control system integrated with the Rete algorithm. Training iterations for the Rete algorithm in the current embodiment of the invention are shown in FIG. 14, whereby the feedback control system of FIG. 13 that implements the trading agent 1600 of FIG. 11 can be operated both in simulation or actual trading mode, or as a combination of both, in trader emulation mode, by using the data block 5000 from the Market Microstructure Data Generator (MG) 50 and the data block 2063 from Market Interface Module (MI) 20, as depicted in FIG. 8.

10. Trading Algorithm Calibrator (AC)

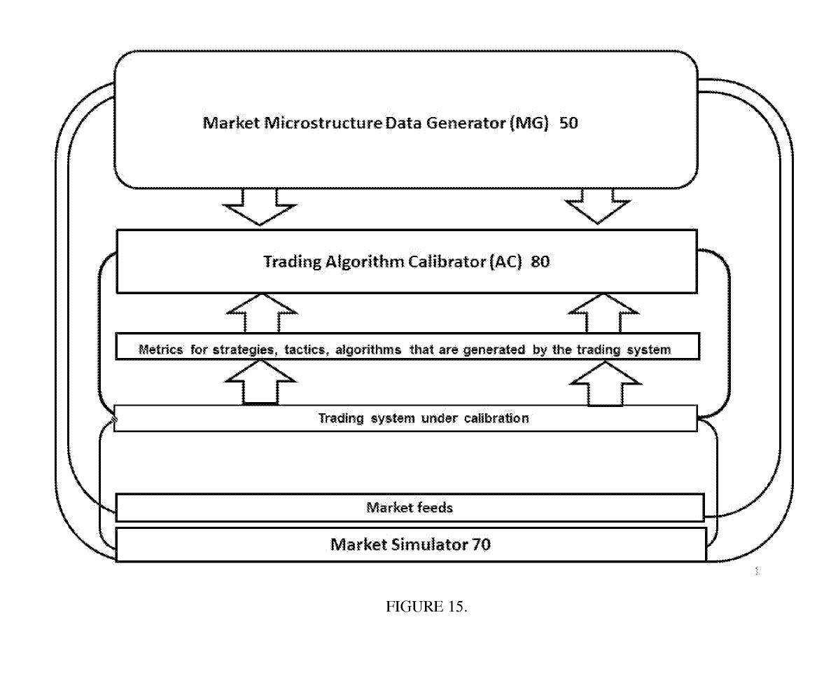

Referring now to FIG. 15, the Trading Algorithm Calibrator (AC) 80 of FIG. 1 integrates all the other components of Market Microstructure Data Appliance (MMDA) to provide a test bench for validating and calibrating in real time the parameters of trading strategies and their underlying assumptions. Most trading algorithms include mathematical and heuristic assumptions about the behavior of markets. These assumptions include signal processing techniques, stochastic pricing and risk models, and estimators of market behavior, and semi-numerical models that are often referred to as stylized facts. AC enables traders to validate these assumptions continuously and to calibrate their trading algorithms and profit/loss profiles by benchmarking these algorithms metrics against the analytics feeds that are provided by the MMD appliance. AC enables this calibration by providing real time benchmarking of market microstructure data feeds with traders' algorithms according to statistical measures including mean, median, mode, variance, dispersion, skewness and kurtosis for each market microstructure data. These statistical measures include relative error estimates for deviations from stationarity within each feed's time horizons. These calibrations can be executed in market simulation and emulation modes by using the stochastic process libraries for market models, such as Poisson, Weilbull, Lognormal, and others that were listed above. Hence, the trader is empowered to track how close or how far the models in the trading system under test are to the actual market behavior by checking the differences of the various data series that are generated by the trading system against functional reconstructions of distributions of the analogue data series from the market. AC's calibrations are conducted according to the five operating modes of the market simulator (MS):
1. Baseline market simulation
2. Order flow emulation
3. Matching engine emulation
4. Concurrent order flow and matching engine emulation

The Trading Algorithm Calibrator provides means for calibrating trading strategies during market simulation, market emulation, paper trading, and actual trading volume for the following:
1. Estimating trading volume

1.1. Estimating liquidity

1.2. Estimating volatility

1.3. Estimating correlations among assets
2. Risk Estimation

2.1. Market impact risk

2.2. Timing risk

2.3. Drawdown risk

2.4. Implementation shortfall risk
3. Structuring the trade

3.1. Customizing the trade strategy

3.2. Customizing the tactics for the strategy

3.3. Market entry/exit thresholds

3.4. Trade horizon estimate
4. Order selection

4.1. Order types

4.2. Order qualifiers
5. Selection of order sequence

5.1. Lot structuring

5.2. Lot sizing

5.3. Lot splitting/scaling/pyramiding/layering
6. Estimating trade costs

6.1. Missed opportunity costs

6.2. Fixed costs
7. Performance assessment

7.1. P/L statistics

7.2. Algorithm and parameter calibration

MG's market estimation and risk algorithms that are delivered as data feeds along with MS enable traders to improve strategies dynamically and in real time to account for changes in market microstructure profiles, without having to implement market data analysis functions in software or hardware. Such market data analyses and the generation of one's own market metrics to be used by trading algorithms and strategies are major cost items for deploying trading systems. The speed of execution of the software and hardware for the computation of these market metrics prevents many traders from discerning market microstructure dynamics in high time resolutions, and therefore prevents them from using their trading strategies for higher speed trading.

MG's market microstructure data feed is independent of any assumptions that are used for analytical, empirical, heuristic and stylized models that have been so far developed to characterize market dynamics. MG's data feeds, along with functions provided by MS and AC, enable traders to track the deviations of their models from the actual market behavior over dynamic and different time horizons. Traders can characterize these deviations in terms of error metrics that are also dynamic. This enables the use of these models for trading purposes while tracking their deviations of the parameters of these models from their characterization of actual market data patterns.

11. Baseline Technologies of the Invention

It will be understood by those having skill in the art of analytics appliances and various parts of real time control systems that MMDA may be realized as software and/or hardware modules running on a distributed computer system. Alternatively, MMDA may be provided as a standalone system. For either case, MMDA includes coherent data management and process synchronization features that are available in several publish and subscribe (PAS) architectures. In its current embodiment, MMDA is deployed as a data-centric pipeline of processes, whereby the PAS architecture delivers dynamic management of the elements of its state machines, including data flow concurrency, data flow aggregation, data flow granulation, data buffer sizing, concurrent event control, multi-threaded event processing, and system-wide quality control processes for the integrity of data flow and analytics. The implementation of PAS provides the middleware software layer between the operating system and MMDA's functions. It manages all lower level communication between processors, boards, servers, grids, clouds. MMDA's architecture is independent of any specifics of the underlying hardware, including microprocessors, graphical processing units (GPU) and field programmable gate arrays (FPGA) that MMDA can be mapped onto. These hardware elements are just further enhancers of the performance of MMDA.

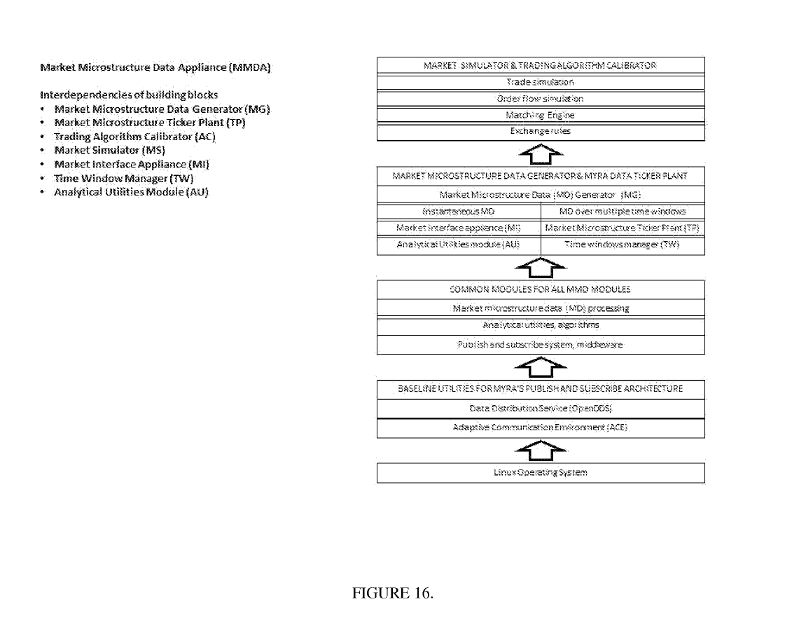

The current embodiment of the invention is deployed using the Data Distribution Service (DDS) protocol by Object Management Group. DDS provides for MMDA's components to share the same baseline data-centric and distributed architecture for concurrent and high-speed data processing, and for the deployment of MMDA's analytics functions as granular and distributed processes over the whole MMDA pipeline. As shown in FIG. 16, this baseline architecture in the current embodiment of the invention enables economies of scale whereby ticker plants, complex event processing engines and analytics on high-speed market data are integrated as components of a single, distributed appliance. DDS's ease of configurability in hardware or software enhances MMDA's ability to be configured for different trading platforms' diverse operating environments. However, the invention can be deployed by using other middleware protocols as well as other publish and subscribe systems to deliver the same functions as the current embodiment.

MMDA's PAS partitions data flows over concurrent and parallel paths, executes MMD's analytics over these concurrent data flows, provides effective coordination of public and subscribe events to sustain data and logic integrity, tracks in real-time its own performance, and provisions for corrective action if event coordination functions fail.

The PAS architecture covers consistently:
the hardware architecture, including multi core chips with effective concurrency of:
   on-processor memory;
   data buses on microprocessors;
   data buses on each board, data buses between microprocessors;
   data paths on each server, data paths across grids;
the operating system's features for data and process concurrency;
software architecture including middleware with dynamic data buffering and multi casting across the PAS;
in-memory, non-relational data bases in the appliance for fast processing of:

data feeds;
the internal data that is generated by the appliance during computations;
data that is passes between components of the appliance, by using the PAS;
partitioning of market data analytics algorithms both in data and logic with effective use of the PAS.

MMDA's middleware is easily reconfigurable and scalable on heterogeneous computer boards and servers, grids, and clouds, while keeping the data throughput rates across the installation at their highest possible rates without losing data integrity and without corruption of logic integrity.

MMDA's ground-up, data path centric architecture is deployed over the whole appliance, including:

the hardware:
microprocessors, and data buses on microprocessors,
data buses between microprocessors, GPU and FPGA racks, and memory racks,
data paths on each server,
networks across grids of servers;
application programming interfaces (API) to third-party systems, VARs' and OEMs' databases;
the operating system's features for data and process concurrency (effective in Linux and Unix);

the software:

dynamic data buffering and multi casting across the PAS;
in-memory, non-relational data bases in the appliance for fast processing of:
external data feeds;
internal data flows that are generated by the appliance;
data that is passes between components of the PAS;

the interfaces of the appliance's grids of servers with those of banks and other data providers.

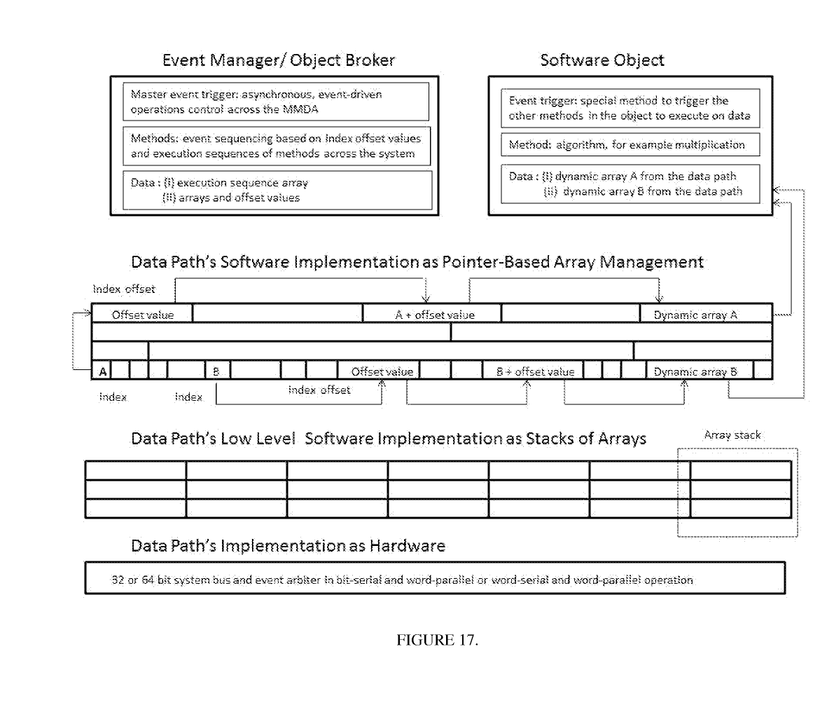

MMDA's software architecture is object oriented and is implemented in C++ and Java in the current embodiment of the invention. As shown in FIG. 17, this architecture provides efficiencies with data structures, pointer-based management of the data path, organization of classes and objects, garbage collection and memory management during execution.

In the drawings and specifications of the invention, there have been disclosed typical embodiments in the current preferred implementation of the invention. Although specific terms are employed in these drawings and specifications, these terms are used in descriptive and generic sense only, and not for purpose of limitation.

That which is claimed:

1. A method, the method comprising:
constructing probability distributions of time series numerically over intervals from the statistical properties of these time series;
storing these time series in sequential time windows each with different time horizons and time scales;
representing market signals, and market microstructure data feeds, including market estimates, risk measures, trading algorithms, tradability metrics consistently via numerical functional reconstruction;
deriving data feeds for market microstructure information, market estimates, risk measures, trading algorithms, tradability metrics from market data feeds using numerical functional reconstruction over multiple time intervals;
delivering these derived feeds to traders as algorithm feeds that can be integrated in real time by users' trading systems;
synchronizing and integrating market data feeds with these derived feeds in ticker plants, reducing substantially traders' needs to deploy separate analytics and complex event processing apparatus over their data series;
integrating numerical functional reconstruction with inductive reasoning techniques to provide a consistent mathematical and heuristic agent-based tool for market simulation;
augmenting inductive reasoning techniques with predictive and corrective methods to iteratively train trading agents to operate as different types of market participants, including market maker, market taker, high frequency trader, scalper, institutional trader, in market simulations; and
merging market simulations to run concurrently with actual trading to enable users of the appliance to calibrate their trading systems effectively in market emulation mode.

2. The method of claim 1 wherein said numerical constructions of distribution functions can be deployed over dynamic time horizons whereby the numerical constructions are validated for stationarity and, strengths of statistical measures according to validation tests and threshold metrics that use numerical measures of moments, modes, means, dispersions of underlying data;
wherein these validation tests are conducted over time series of statistics of the underlying series, thereby providing a consistent baseline for numerically characterized stochastic processes; and
wherein the metrics of these tests are interchangeable with metrics with different formulas that provide the same functionality, such as, for example, the replacement of Pearson correlation test with polynomial or nonlinear correlation or cointegration tests.

3. The method of claim 1 wherein said deployment of data and numerically constructed functions over time horizons can be executed by using numerous time scaling methods, including logarithmic and other nonlinear methods, whereby metrics such as volatility over such horizons will be consistent over horizons that cover multiple time scales;
wherein these metrics will be updated sequentially as underlying market data or derived numerically constructed functions that will be shifted across these multiple time horizons in real time;
wherein the time windowing method will provide a consistent and synchronized set of metrics, including and not limited to mean, variance, skewness, kurtosis, autocorrelation, correlation for market data and market microstructure data, whereby such consistency and synchronization are crucial for effective real-time integration of these feeds in trading systems; and
wherein the underlying market data and market microstructure data feeds can be selectively delivered to users according to their time frequencies of interests and their latency profiles for accessing markets.

4. The method of claim 1 wherein the trading agents of the market simulator are implemented as feedback control systems whereby:
agents' simulation of different types of market participants are determined consistently by relative margins on risk metrics and market estimates, and agents' ensuing use of statistical libraries to generate stochastic processes that are uniquely and numerically characterized according to these margin values;
thereby enabling automated switching of market participants' roles during market simulation, enabling market simulation and emulations with dynamically evolving roles for real or simulated market participants; and
wherein simulated markets' and agents' behaviors are fully backward traceable due to consistent use of numerical functional reconstruction across the whole appliance.

5. The method of claim 1 whereby the calibration of users' trading strategies are consistently checked against market data and market microstructure data feeds that are numerically constructed without any assumptions about markets' behavior and without any analytically closed form models, thereby providing a consistent benchmark for trading algorithm calibration across wide trading frequency and market regimes, and for diverse trading strategies.

6. The method of claim 1 whereby the Market Microstructure Data Appliance is deployed as a publish and subscribe system by using the Data Distribution Service protocol that is scalable and reconfigurable in terms of bandwidth and throughout at any connection point or across any process within the appliance, thereby enabling the mapping on the components of the appliance on centric or distributed architectures and as functions implemented in software and hardware, while maintaining the coherence of its operating logic.
